(19) United States
(12) Patent Application Publication
(10) Pub. No.: US 2024/0278248 A1
(43) Pub. Date: Aug. 22, 2024

(54) CRYOGENIC STORAGE RACKS AND ASSOCIATED SYSTEMS, DEVICES, AND METHODS

(71) Applicant: Sana Biotechnology, Inc., Seattle, WA (US)

(72) Inventors: Lindong Weng, Seattle, WA (US); Hung-Wei Chih, Seattle, WA (US)

(21) Appl. No.: 18/570,351

(22) PCT Filed: Jul. 7, 2022
(86) PCT No.: PCT/US22/73520

§ 371 Date: Dec. 14, 2023

Related U.S. Application Data
(60) Provisional application No. 63/221,243, filed on Jul. 13, 2021.

(51) Int. Cl. B01L 7/00; B01L 9/04; B01L 9/06

(52) U.S. Cl. CPC B01L 7/50; B01L 9/04; B01L 9/06; B01L 2200/023; B01L 2300/1894

(57) ABSTRACT

Cryogenic storage racks (“cryoracks”) and associated systems, devices, and methods are described herein. In one embodiment, a cryorack includes a first plate, a second plate, and a plurality of standoffs separating the first and second plates. The first plate can include openings configured to receive cryogenic vials. The cryorack can be carried by a cryorack holder that is positionable within a controlled-rate freezer. The cryorack holder can include a first shelf, a second shelf, and a plurality of standoffs separating the first and second shelves. The cryorack can be positioned over a first opening formed in the first or second shelf, and a portion of the cryorack can be inserted into the first opening or a second opening positioned along a perimeter of the first opening. In some embodiments, the cryorack is dimensioned to fit within a liquid nitrogen storage rack that is positionable within a liquid nitrogen storage container.

### CROSS-REFERENCE TO RELATED APPLICATIONS

This application claims the benefit of U.S. Provisional Patent Application No. 63/221,243, filed Jul. 13, 2021, which is incorporated by reference herein in its entirety.

### TECHNICAL FIELD

The present disclosure relates generally to cryogenic storage racks and associated systems, devices, and methods. For example, embodiments of the present technology relate to cryogenic storage rack systems for cryopreservation of biological material.

### BACKGROUND

Cryopreservation is a process by which biological material (e.g., tissue, cells, etc.) is preserved by cooling the biological material to low temperatures (e.g., to approximately −130° Celsius or less). At these low temperatures, enzymatic or chemical activity that might otherwise damage the biological material is slowed or effectively stopped. When cryopreservation procedures are optimized, detrimental events (e.g., osmotic shock, intracellular ice formation, ice recrystallization, etc.) can be avoided to ensure viability and functionality of post-thaw biological material. Thus, cryopreservation can successfully preserve biological material for use at a later time, at which point the biological material can be thawed.

A common method of cooling biological material to the low temperatures required for cryopreservation is controlled-rate and slow freezing (also known as slow programmable freezing). During controlled-rate and slow freezing, the biological material is cooled in accordance with programmable sequences. For example, a controlled-rate freezer or other instrument can be used to cool biological material at a specified rate (e.g., 1° Celsius per minute) until the biological material reaches a desired temperature. In some instances, the biological material can then be transferred to a storage container where the biological material can be cryopreserved in liquid nitrogen (LN₂) or its vapor phase.

Biological material destined for cryopreservation is often stored in cryopreservation vials (also known as cryovials). The cryovials can be placed in a cryopreservation freezing rack and positioned in a controlled-rate freezer to cool the biological material to a desired temperature. Cryovials can then be (a) transferred from the cryopreservation freezing rack to a cryopreservation storage box and (b) positioned in a liquid nitrogen storage container for long-term storage.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments depicted, but are for explanation and understanding only.

FIG. 1 is a partially schematic, perspective view of a cryogenic storage rack system configured in accordance with various embodiments of the present technology.

FIG. 2 is a partially schematic, perspective view of cryogenic storage racks or modules configured in accordance with various embodiments of the present technology.

FIG. 2A is a partially schematic, exploded view of another cryogenic storage rack or module configured in accordance with various embodiments of the present technology.

FIG. 3 is a partially schematic, perspective view of a cryogenic storage rack holder or frame configured in accordance with various embodiments of the present technology.

FIG. 3A is a partially schematic, exploded view of another cryogenic storage rack holder or frame configured in accordance with various embodiments of the present technology.

FIG. 4A is a partially schematic, perspective view of a controlled-rate freezer configured in accordance with various embodiments of the present technology.

FIG. 4B is a partially schematic, front view of a cryogenic storage rack system installed in the controlled-rate freezer in accordance with various embodiments of the present technology.

FIG. 5A is a partially schematic, perspective view of a cryogenic storage rack system configured in accordance with various embodiments of the present technology.

FIG. 5B is a line plot corresponding to the cryogenic storage rack system of FIG. 5A.

FIG. 6A is a partially schematic, perspective view of a liquid nitrogen storage container configured in accordance with various embodiments of the present technology.

FIG. 6B is a partially schematic, perspective view of cryogenic storage racks positioned in a liquid nitrogen storage rack configured in accordance with various embodiments of the present technology.

FIG. 7 is a partially schematic, perspective view of a cryogenic storage rack positioned in a cryogenic storage box configured in accordance with various embodiments of the present technology.

FIG. 8 is a flow diagram illustrating a method of cryopreserving biological material in accordance with various embodiments of the present technology.

### DETAILED DESCRIPTION

The following disclosure describes cryogenic storage racks, and associated systems, devices, and methods. In one embodiment, a cryorack includes a first plate, a second plate, and a plurality of standoffs separating the first and second plates. The first plate and/or the second plate can include openings configured to receive cryogenic vials (“cryovials”). In some embodiments, the cryovials can be ready-to-fill closed cryovials. The cryorack can be carried by a cryorack holder that is positionable within a controlled-rate freezer. The cryorack holder can include a first shelf, a second shelf, and a plurality of standoffs separating the first and second shelves. The cryorack can be positioned over a first opening formed in the first shelf or the second shelf, and a portion of the cryorack can be inserted into the first opening or a second opening positioned along a perimeter of the first opening. In some embodiments, the cryorack is dimensioned to fit within a liquid nitrogen storage rack or tower that is positionable within a liquid nitrogen storage container.

### A. Overview

As discussed above, it is often desirable to store biological material (e.g., tissue, cells, etc.) at low temperatures, such as within a controlled-rate freezer or a liquid nitrogen storage container. To facilitate freezing of the biological material, the biological material can be placed within a cryogenic vial (a “cryovial”) and positioned within a controlled-rate freezer. Once the biological material has been cooled to a desired temperature, the biological material can be transferred to and preserved within a liquid nitrogen storage container.

To this end, many cryopreservation systems include (a) a cryopreservation freezing rack for the controlled-rate freezer and (b) a separate, cryopreservation storage box for the liquid nitrogen storage container. More specifically, cryovials are positioned within the cryopreservation freezing rack, and the cryopreservation freezing rack is loaded into a rack holder or frame that is positioned within the controlled-rate freezer. Once the biological material is cooled to a desired temperature, the cryopreservation freezing rack is removed from the controlled-rate freezer, and the cryovials are individually transferred from the cryopreservation freezing rack to a cryopreservation storage box. The cryopreservation storage box is then loaded into a liquid nitrogen storage rack or tower, and the liquid nitrogen storage rack is then positioned into a liquid nitrogen storage container for long-term storage of the biological material.

Other cryopreservation systems employ ready-to-fill closed cryovials (e.g., AT-Closed Vials® manufactured by Aseptic Technologies of Gembloux, Belgium). In these systems, the ready-to-fill closed cryovials are placed within cryopreservation storage boxes instead of freezing racks, and the cryopreservation storage boxes are positioned within a controlled-rate freezer. Once the biological material is cooled to a desired temperature, the cryopreservation storage boxes are transferred to a liquid nitrogen storage rack and positioned in a liquid nitrogen storage container for long-term storage of the biological material.

The inventor of the present technology has realized several problems and disadvantages with the cryopreservation systems described above. For example, the inventor has realized the cryopreservation freezing racks described above cannot fit within a liquid nitrogen storage rack. Thus, when transferring biological material from a controlled-rate freezer to a liquid nitrogen storage container using the cryopreservation systems described above, biological material is often transferred from a cryopreservation freezing rack that fits within the controlled-rate freezer to a separate, cryopreservation storage box that fits within the liquid nitrogen storage rack. (This process is reversed when transferring the biological material from the liquid nitrogen storage container to the controlled-rate freezer.) Transferring individual cryovials from a cryopreservation freezing rack to a cryopreservation storage box (or vice versa) is time consuming and involves extensive handling of the biological material. As a result, the temperature of the biological material commonly changes (e.g., increases) during these transfer processes while the biological material is positioned outside of the controlled-rate freezer and the liquid nitrogen storage container. These temperature changes and the extensive handling of the biological material can damage or otherwise compromise the integrity (e.g., the quality, the viability, the functionality, etc.) of the biological material.

Furthermore, the cryopreservation freezing racks described above cannot (e.g., are not sized to) carry ready-to-fill closed cryovials. Thus, when ready-to-fill closed cryovials are employed, the ready-to-fill closed cryovials are instead positioned within a cryopreservation storage box, and the cryopreservation storage box is installed into a controlled-rate freezer. Cryopreservation storage boxes, however, typically include structures that at least partially enclose or surround cryovials positioned inside of them. Thus, the structures of the cryopreservation storage boxes and/or dense positioning of the cryovials within the cryopreservation storage boxes can stifle the flow of air, liquid nitrogen, nitrogen vapor, or another cooling medium within a controlled-rate freezer and/or a liquid nitrogen storage container. As such, the cryovials, when positioned within the controlled-rate freezer in a cryopreservation storage box, are often unequally exposed to the air or other cooling medium flowing within the controlled-rate freezer. This problem is especially prevalent when a controlled-rate freezer is packed with a large number of such cryopreservation storage boxes because cryovials located nearer a center of the controlled-rate freezer are exposed to the air or other cooling medium to a lesser extent than cryovials located nearer a perimeter of the controlled-rate freezer. As a result, a significant thermal lag is often observed between (a) a time the interior of the controlled-rate freezer and/or biological material contained within cryovials positioned nearer the perimeter of the controlled-rate freezer begin to cool or reach a specific temperate and (b) a time biological material contained within cryovials positioned nearer the center of the controlled-rate freezer begin to cool or reach the specific temperature. In addition, it is common to observe a large disparity in temperatures between biological material stored in cryovials positioned in a first cryopreservation storage box and biological material stored in cryovials positioned in a second cryopreservation storage box at a different location within the controlled-rate freezer.

To address the above concerns, the inventor has developed cryogenic storage rack systems that include cryogenic storage racks (“cryoracks”) and/or cryogenic storage rack holders or frames (“cryorack holders”). In some embodiments, the cryoracks each include a first plate, a second plate, and a plurality of standoffs separating the first plate from the second plate. The first and/or second plates can include one or more openings configured to receive ready-to-fill closed cryovials, traditional cryovials, and/or other cryovials of one or more shapes or sizes (e.g., diameters, heights, etc.). The separation between the first and second plates and the one or more openings in the first and/or the second plates contribute to an open framework of the cryoracks. In addition, several cryoracks of the present technology are dimensioned such that they can be positioned and stored within (a) a cryorack holder of the present technology, (b) a conventional holder or frame for a controlled-rate freezer, and/or (c) a liquid nitrogen storage rack positionable within a liquid nitrogen storage container. As such, the cryoracks of the present technology facilitate (a) cooling biological material using cryovials of a variety of shapes and sizes (including ready-to-fill closed cryovials), and (b) transferring biological material between a controlled-rate freezer and a liquid nitrogen storage container by simply transferring the cryoracks between the controlled-rate freezer and the liquid nitrogen storage container. Therefore, the present technology obviates the practice of transferring cryovials between cryopreservation freezing racks and cryopreservation storage boxes when the biological material is transferred between the controlled-rate freezer and the liquid nitrogen storage container. As a result, the present technology eliminates, reduces, and/or minimizes (i) temperature changes in and/or the amount of handling of biological material during the transfer processes and/or (ii) the time the biological material is positioned outside of a controlled-rate freezer and a liquid nitrogen storage container. In turn, the present technology eliminates, reduces, and/or minimizes the risk of damaging or otherwise compromising the integrity of the biological material.

In some embodiments, the cryorack holders of the present technology can include first shelves, second shelves, and a plurality of standoffs separating the first and second shelves. The first and/or second shelves can include one or more openings that can be positioned beneath a cryorack and/or used to retain a cryorack within the cryorack holder. The separation between the first and second shelves and the one or more openings in the first and/or the second shelves contribute to an open framework of the cryorack holders. In addition, several cryorack holders of the present technology are dimensioned such that they can be positioned within a controlled-rate freezer. For example, a cryorack holder of the present technology can be dimensioned to fit within an interior of a controlled-rate freezer and to maximize a number of cryoracks that can be positioned within the interior of the controlled-rate freezer while maintaining generally uniform cooling of biological material regardless of position of the biological material within the controlled-rate freezer. Additionally, or alternatively, a cryorack holder of the present technology can be configured to simultaneously carry a plurality of cryoracks that are configured to store cryovials having uniform and/or varying shapes or sizes. As such, the present technology offers the flexibility to (e.g., simultaneously or otherwise) freeze biological material in different cryovial configurations.

The open framework of the cryoracks and/or of the cryorack holders of the present technology facilitate air, liquid nitrogen, nitrogen vapor, or another cooling medium to flow more freely and/or uniformly through the cryoracks, the cryorack holders, a controlled-rate freezer, and/or a liquid nitrogen storage container. Thus, biological material contained in cryovials stored within cryoracks and/or cryorack holders of the present technology and positioned within a controlled-rate freezer and/or a liquid nitrogen storage container are more uniformly exposed to the air, liquid nitrogen, nitrogen vapor, or other cooling medium. Additionally, or alternatively, the open framework of the cryoracks and/or the cryorack holders facilitates retrieval of individual cryovials, such as from a liquid nitrogen archiving system.

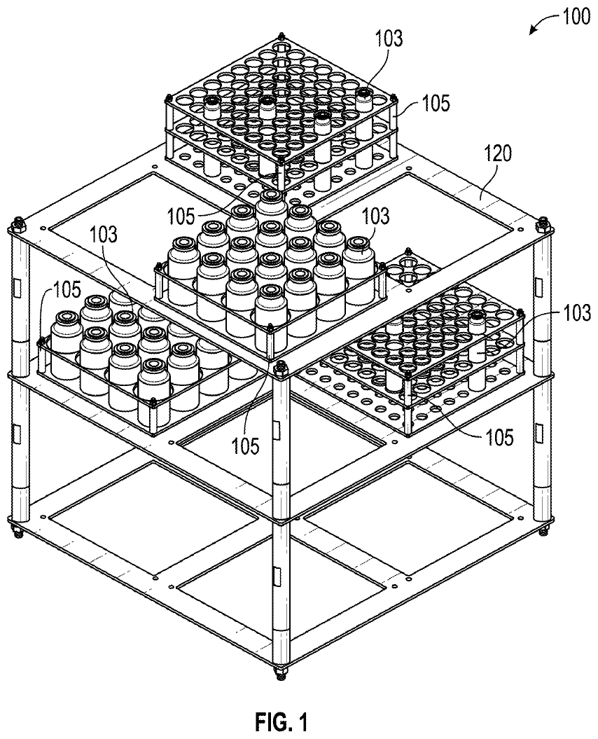

Certain details are set forth in the following description and in FIGS. 1-8 to provide a thorough understanding of various embodiments of the present technology. Other details describing well-known structures, systems, and methods often associated with cryogenic storage rack systems and/or cryopreservation procedures, however, are not set forth below to avoid unnecessarily obscuring the description of various embodiments of the technology.

Many of the details, dimensions, angles, and other features shown in FIGS. 1-8 are merely illustrative of particular embodiments of the technology. Accordingly, other embodiments can have other details, dimensions, angles, and features without departing from the spirit or scope of the present technology. In addition, those of ordinary skill in the art will appreciate that further embodiments of the technology can be practiced without several of the details described below.

### B. Selected Embodiments of Cryogenic Storage Rack Systems, and Associated Systems, Devices, and Methods

### 1. Cryogenic Storage Racks Associated Systems and Devices

FIG. 1 is a partially schematic, perspective view of a cryogenic storage rack system 100 (“the system 100”) configured in accordance with various embodiments of the present technology. As shown, the system 100 includes (a) a plurality of cryogenic storage racks or modules 105 (“cryoracks 105”), and (b) a cryogenic storage rack holder or frame 120 (“the cryorack holder 120”). As described in greater detail below, each of the cryoracks 105 is configured (a) to carry (e.g., support, position, hold, store) one or more cryopreservation vials 103 (“cryovials 103”) and (b) to be carried by the cryorack holder 120. Although shown with a single cryorack holder 120 in FIG. 1, the system 100 can include a lesser or greater number of cryorack holders 120 (e.g., zero cryorack holders 120 or more than one cryorack holder 120) in other embodiments. Additionally, or alternatively, although shown with four cryoracks 105 in FIG. 1, the system 100 can include a lesser or greater number of cryoracks 105 (e.g., one to three cryoracks 105 or more than four cryoracks 105) in other embodiments.

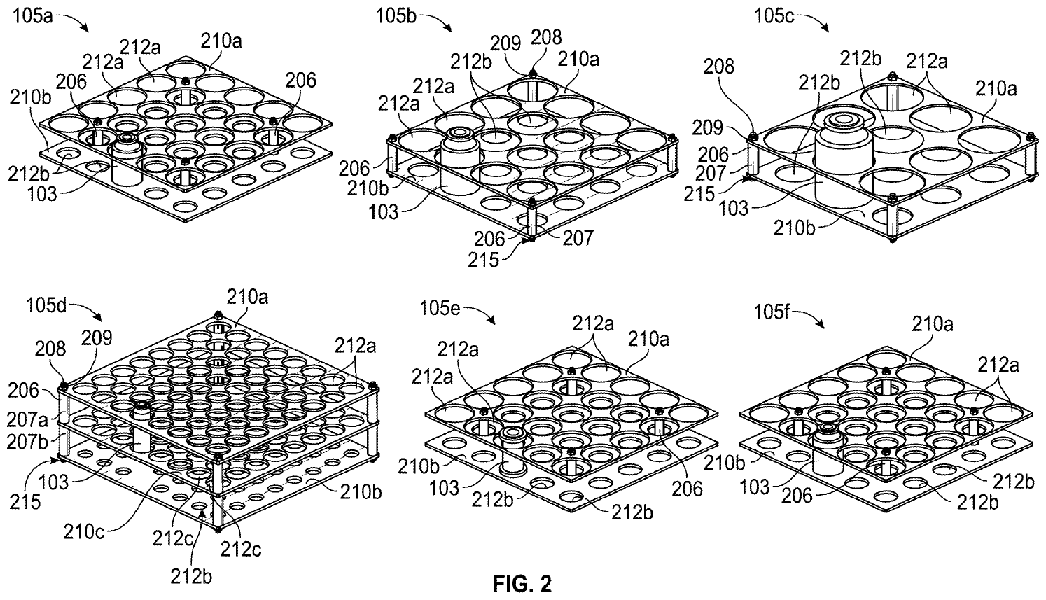

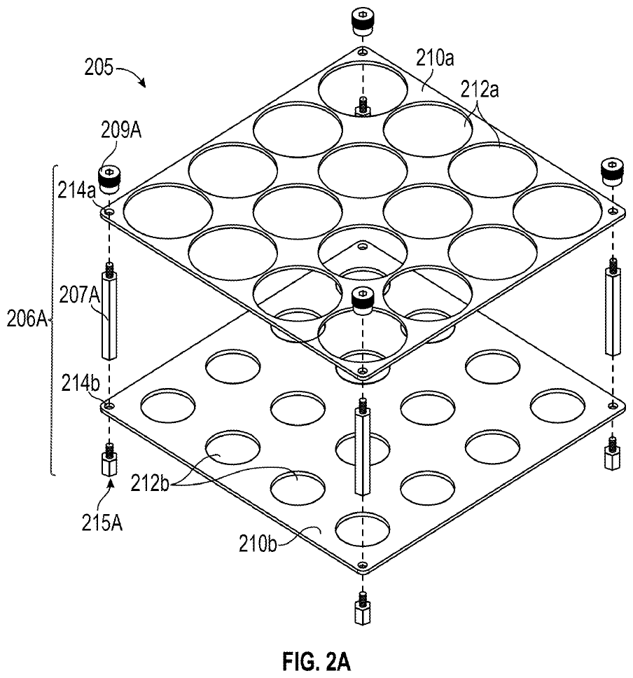

FIG. 2 is a partially schematic, perspective view of several cryoracks 105 configured in accordance with various embodiments of the present technology. In particular, FIG. 2 illustrates six cryoracks 105 that are identified individually as cryoracks 105a-105f. As shown, each cryorack 105 includes a top plate 210a; a bottom plate 210b; and a plurality of standoffs, pillars, or spacers 206 (“standoffs 206”) separating the top plate 210a from the bottom plate 210b. Each of the standoffs 206 in FIG. 2 includes a body portion 207, a center rod 208, and a retention mechanism 209. The cryorack 105d further includes a middle plate 210c (a) positioned between the top plate 210a and the bottom plate 210b and (b) separated from the top and bottom plates 210a and 210b by the corresponding plurality of standoffs 206. Although shown with either two or three plates 210 in FIG. 2, cryoracks 105 configured in accordance with other embodiments of the present technology can include a greater (e.g., more than two) or lesser (e.g., one) number of plates 210. For example, a cryorack 105 of the present technology can include multiple middle plates 210c in addition to a top plate 210a and a bottom plate 210b.

In some embodiments, the top plates 210a, the bottom plates 210b, the middle plates 210c, and the standoffs 206 can be formed of one or more suitable materials that maintain integrity at cryogenic temperatures. For example, the top plates 210a, the bottom plates 210b, the middle plates 210c, the body portions 207, the center rods 208, and/or the retention mechanisms 209 can be formed of one or more metals, glasses, and/or thermoplastics (e.g., polypropylene, polycarbonate, etc.). In the illustrated embodiment, each component of the cryoracks 105a-105f are formed of one or more metallic materials.

As shown, the body portions 207 of the standoffs 206 are generally cylindrical. In other embodiments, a body portion 207 of a standoff 206 can have a different general shape (e.g., block, pentagonal, hexagonal, octagonal, etc.). In these and other embodiments, the body portion 207 can include flat or machined portions or surfaces to, for example, facilitate (i) turning the body portion 207 or (ii) holding the body portion 207 in place (e.g., using a wrench or another tool). In these and still other embodiments, the body portion 207 and/or the retention mechanism 209 can be sized and/or shaped to facilitate assembling the standoff 206 and/or a cryorack 105 via hand-tightening and/or without the use of tools. The body portion 207 is (a) positioned between the top plate 210a and the bottom plate 210b of the corresponding cryorack 105 and (b) serves as a spacer to offset the top plate 210a away from the bottom plate 210b by, for example, a distance corresponding to a length of the body portion 207. In some embodiments, the distance can additionally or alternatively correspond at least in part to a height of a cryovial 103 that can be received in and carried by the corresponding cryorack 105 (as discussed in greater detail below). For example, the distance between the top plate 210a and the bottom plate 210b of a first cryorack 105 (e.g., the cryorack 105c or the cryorack 105d) that is configured to carry taller cryovials 103 can be greater than the distance between the top plate 210a and the bottom plate 210b of a second cryorack 105 (e.g., the cryorack 105e) that is configured to carry shorter cryovials 103. This can contribute to the first cryorack 105 having a greater overall height than the second cryorack 105.

As discussed above, the cryorack 105d includes a middle plate 210c positioned between the top plate 210a and the bottom plate 210b. In this embodiment, the body portion 207 can include a first body portion 207a and a second body portion 207b. The first body portion 207a can be positioned between the top plate 210a and the middle plate 210c and can serve as a spacer to offset the top plate 210a away from the middle plate 210c by a first distance. The second body portion 207b can be positioned between the bottom plate 210b and the middle plate 210c and can serve as a spacer to offset the bottom plate 210b from the middle plate 210c by a second distance. In the illustrated embodiment, the first distance and the second distance are equivalent. In other embodiments, the first distance and the second distance can differ, with either of the first and the second distances being greater than the other of the first and second distances.

In some embodiments, the first body portion 207a is a separate component from the second body portion 207b. Alternatively, the first body portion 207a and the second body portion 207b can be a single, integrated component. For example, the body portion 207 can include a first half having a first diameter and a second half having a second, larger diameter. The middle plate 210c in these embodiments can include openings that are sized to slide onto the first half of the body portion 207 but not the second half of the body portion 207 such that the middle plate 210c can be supported by the body portion 207 at a location proximate where the body portion 207 transitions from the first half to the second half. In these and other embodiments, an optional spacer (not shown) can be slid onto the first half of the body portion 207 after the middle plate 210c is slid onto to the body portion 207 but before sliding the top plate 210a onto the first half of the body portion 207. The spacer can be used to offset the top plate 210a away from the middle plate 210c.

The center rod 208 of each standoff 206 can pass through a center of the body portion 207. In some embodiments, the center rod 208 has a larger length than the length of the body portion 207 such that the center rod 208 protrudes beyond the ends of the body portion 207 when the center rod 208 is installed within the body portion 207. Alternatively, the body portion 207 and the center rod 208 can be a single, integrated component such that the body portion 207 includes ends that form the center rod 208 and that protrude outward from the cylindrical center portion of the body portion 207 in each direction.

In some embodiments, at least a portion of the center rod 208 can be threaded. For example, one or both ends of the center rod 208 can be threaded. As another example, a center portion of the center rod 208 can be threaded and can interface with corresponding threading on an interior of the body portion 207 (e.g., such that the threading hinders axial motion of the center rod 208 vis-à-vis the body portion 207 without rotating the body portion 207 or the center rod 208). In some embodiments, the center rod 208 can be a bolt or a screw having, for example, a hexagonal- or other-shaped head at one end and a threaded end at the other end. Alternatively, the center rod 208 can lack a head (e.g., similar to a set screw).

As shown in FIG. 2, the center rod 208 can extend through the body portion 207, the top plate 210a, the bottom plate 210b, and/or the middle plate 210c. In this regard, the top plate 210a, the bottom plate 210b, and/or the middle plate 210c can include openings sized to allow the center rod 208 to extend therethrough. One or more ends of the center rod 208 can be configured to receive a retention mechanism 209. For example, when one or more ends of the center rod 208 are threaded, the end(s) of the center rod 208 can receive a nut or other retention mechanism 209 having corresponding threading. In embodiments in which the center rod 208 includes a head at one end, the center rod 208 can be inserted through the body portion 207 and/or the plates 210a, 210b, and/or 210c such that the head of the center rod 208 interfaces with an outer surface of the top plate 210a or an outer surface of the bottom plate 210b.

As the center rod 208 receives the retention mechanism(s) 209 at its end(s), the center rod 208 and the retention mechanism 209 (a) can clamp (e.g., cinch, pull, etc.) the plates 210a, 210b, and/or 210c toward one another and/or against the body portion 207 of the standoff 206 and (b) can limit motion of the plates 210a, 210b, and/or 210c along an axis of the center rod 208. When (i) the body portion 207 is positioned between the plates 210a, 210b, and/or 210c; (ii) the center rod 208 is extended through the body portion 207 and/or the plates 210a, 210b, and/or 210c; and (iii) the retention mechanism(s) is/are installed on the end(s) of the center rod 208, the standoffs 206 can retain the plates 210a, 210b, and/or 210c against the body portion 207 and/or in the stacked arrangement or configuration illustrated in FIG. 2. In embodiments in which the center rod 208 includes a head, the head can similarly be used to retain the plates 210a, 210b, and/or 210c against the body portion 207 and/or in the stacked arrangement.

Four standoffs 206 are used in FIG. 2 to position and hold the plates 210a, 210b, and/or 210c of the cryoracks 105 in the stacked arrangement. A different number (e.g., three or less, or five or more) of standoffs 206 can be used in other embodiments. For example, the cryorack 105d can include (a) four standoffs 206 that are used to retain the bottom plate 210b and the center plate 210c in the stacked arrangement, and (b) four (or a different number of) additional/separate standoffs 206 that are used to retain the middle plate 210c and the top plate 210a in the stacked arrangement. Continuing with this example, the standoffs 206 holding the middle plate 210c to the bottom plate 210b may or may not be vertically aligned with the standoffs 206 holding the middle plate 210c to the top plate 210a.

The standoffs 206 of the cryoracks 105b, 105c, and 105d in FIG. 2 are positioned along a perimeter and at corners of the cryoracks 105b, 105c, and 105d. In contrast, the standoffs 206 of the cryoracks 105a, 105e, and 105f are positioned closer to a center of the cryoracks 105a, 105e, and 105f. In other embodiments, the standoffs 206 can be positioned at other locations within the cryoracks 105. The positioning of the standoffs 206 in each of the cryoracks 105a-105f can facilitate a generally uniform weight distribution across the corresponding cryoracks 105 (e.g., when the cryoracks 105a-105f are empty of cryovials 103 and/or when the cryoracks 105a-105f are filled with cryovials 103).

As shown in FIG. 2, the standoffs 206 of each cryorack 105 include feet or protrusions 215 (e.g., nubs, pegs, stubs, etc.) that extend beyond the bottom, outer surfaces of the bottom plates 210b at least when the cryoracks 105 are assembled. In some embodiments, the protrusions 215 are formed at least in part by an end of the center rod 208, a head of the center rod 208, and/or a retention mechanism 209 installed on an end of the center rod 208. As discussed in greater detail below, the protrusions 215 can facilitate positioning and/or retaining the corresponding cryorack 105 within a cryorack holder 120 (FIG. 1).

FIG. 2A is a partially schematic, exploded view of another cryorack 205 configured in accordance with various embodiments of the present technology. The cryorack 205 is similar to the cryoracks 105 of FIG. 2. For example, the cryorack 205 includes a top plate 210a and a bottom plate 210b separated from one another and held in a stacked arrangement via use of a plurality of standoffs 206A. In contrast to the standoffs 206 of FIG. 2 that use center rods 208 that extend through the top plate 210a and the bottom plate 210b, the standoffs 206A of FIG. 2A each include a body portion 207A, a retention mechanism 209A, and a protrusion 215A that are used to assemble the cryorack 205. More specifically, the protrusion 215A includes a nub that is configured to extend through an opening 214b in the bottom plate 210b. In the illustrated embodiment, the nub is threaded and is configured to interface with corresponding threading within an interior of the body portion 207A at a bottom end portion of the body portion 207A. Similarly, the body portion 207A of the standoff 206A includes a threaded nub at a top end portion of the body portion 207A. The threaded nub of the body portion 207A is configured to extend through an opening 214a in the top plate 210a and is configured to interface with corresponding threading within an interior of the retention mechanism 209A.

As (i) the threaded nub of the protrusion 215A is received in the corresponding threading of the body portion 207A and (ii) the threaded nub of the body portion 207A is received in the corresponding threading of the retention mechanism 209A, the standoff 206A can (a) clamp (e.g., cinch, pull, etc.) the plates 210a and 210b toward one another and/or against the body portion 207A of the standoff 206A, (b) limit motion of the plates 210a and 210b along a center axis of the standoff 206A, and (c) hold the plates 210a and 210b in a stacked arrangement. In some embodiments, the body portion 207A, the retention mechanism 209A, and the protrusion 215A of a standoff 206A can be hand tightened to one another to, for example, assemble the cryorack 205. Additionally, or alternatively, the body portion 207A, the retention mechanism 209A, and the protrusion 215A of a standoff 206A can be shaped and/or sized such that tools (e.g., a wrench) can be used to tighten the connections of the body portion 207A, the retention mechanism 209A, and the protrusion 215A to one another.

Although each standoff 206A is shown with a single body portion 207A in FIG. 2A, standoffs 206A configured in accordance with other embodiments of the present technology can include multiple body portions 207A. The different body portions 207A of a standoff 206A can be the same size or can vary from one another. For example, different body portions 207A of a standoff 206A can have the same or different lengths. Additionally, or alternatively, each of the different body portions 207A can include a threaded nub at a top end portion and corresponding threading within an interior of the body portion 207A at a bottom end portion. Thus, the different body portions 207A of a standoff 206A can be connected to one another. For example, a first body portion 207A can include a threaded nub that is configured to extend through an opening in a plate (e.g., a middle plate; not shown in FIG. 2A) of the cryorack 205 and to interface with corresponding threading within an interior of a second body portion 207A at a bottom end portion of the second body portion 207A. The different body portions 207A of a standoff 206A can therefore facilitate (a) connecting any number of plates (e.g., three plates comprising a top plate 210a, a bottom plate 210b and a middle plate) of a cryorack 205 to one another, and/or (b) achieving different distances of separation between the plates (e.g., between the top plate 210a and the bottom plate 210b) of a cryorack 205 by varying the number of different body portions 207A and/or the lengths of the different body portions 207A of a standoff 206A.

Furthermore, although shown with openings 214a and 214b in the top and bottom plates 210a and 210b, respectively, one or more of the openings 214a and/or 214b can be slots that extend to the perimeters of the corresponding plates 210a and/or 210b in some embodiments of the present technology. In these embodiments, rather than extending components of a standoff 206A through holes in the plates 210a and/or 210b, components (e.g., the nub of the protrusion 215A and/or the nub of the body portion 207A) can be slid or rotated into corresponding slots in the plates 210a and/or 210b. As the components of the standoff 206A are tightened to one another, the vertical clamping force provided by the standoff 206A can prevent the components of the standoff 206A from slipping or rotating out of the slots in the plates 210A and/or 210b.

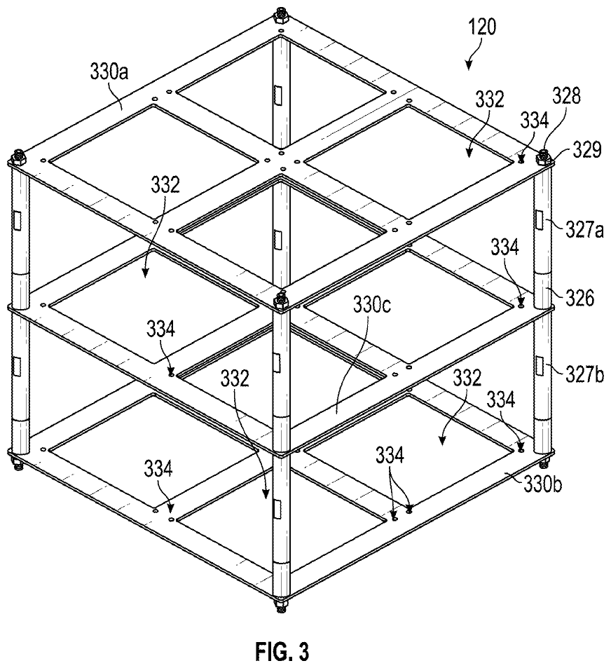

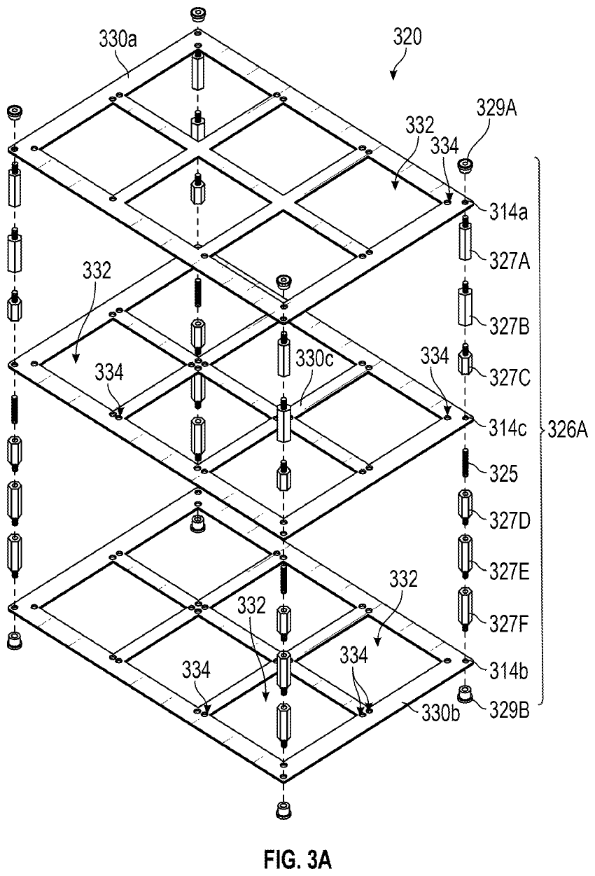

Other methods of assembling the cryoracks 105 and/or the cryorack 205 of FIGS. 2 and 2A are of course possible and within the scope of the present technology. For example, standoffs similar to the standoffs 326A illustrated in FIG. 3A and discussed in detail below can be used to assemble a cryorack in some embodiments of the present technology. As another example, welds or other fasteners or connectors (e.g., rivets, snap fits, snap button connectors, magnets, brad-like connectors, etc.) can be used to connect various portions of the cryoracks 105 and/or 205 together. As a specific example, the top plates 210a, the bottom plates 210b, and/or the middle plates 210c can be welded to standoff structures (e.g., in addition to or in lieu of being clamped to the standoff structures using nuts, bolts, threading, other fasteners, etc.). Additionally, or alternatively, the top plates 210a, the bottom plates 210b, and/or the middle plates 210c may or may not include openings or slots sized to allow a center rod 208, threaded nubs, or other standoff components to extend therethrough. For example, a top plate 210a can be welded to a standoff structure at a bottom surface of the top plate 210a such that the standoff structure does not extend through the top plate 210a to a top surface of the top plate 210a. As another example, a top plate 210a can be welded to a standoff structure at a top surface of the top plate 210a, and/or a bottom plate 210b can be welded to a standoff structure at a bottom surface of the bottom plate 210b. More specifically, at least a portion of the standoff structure can extend through an opening in the top plate 210a and/or through an opening in the bottom plate 210b, and the top plate 210a and/or the bottom plate 210b can be welded to a portion of the standoff structure at the top surface of the top plate 210a and/or at the bottom surface of the bottom plate 210b. The weld at the bottom surface of the bottom plate 210b can form at least a portion of a foot or protrusion 215 and/or 215A that can facilitate positioning and/or retaining the corresponding cryorack 105 and/or 205 within a cryorack holder 120 (FIG. 1), as discussed in greater detail below. As still another example, a bottom plate 210b can be welded to a standoff structure at a top surface of the bottom plate 210b such that the standoff structure does not extend through the bottom plate 210b to a bottom surface of the bottom plate 210b. Continuing with this example, one or more separate feet or protrusion components can be welded to the bottom surface of the bottom plate 210b that can facilitate positioning and/or retaining the corresponding cryorack 105 and/or 205 within a cryorack holder 120 (FIG. 1), or the bottom surface of the bottom plate 210b can include feet or protrusions 215 that are integrated with the bottom plate 210b. Alternatively, the cryorack 105 and/or 205 can lack protrusions 215 and/or 215A in some embodiments of the present technology (e.g., such that a bottom surface of the bottom plate 210b can sit flush on a supporting surface).

Referring again to FIG. 2, the top plate 210a, the bottom plate 210b, and/or the middle plate 210c of each cryorack 105 are generally rectangular shaped. Additionally, the plates 210a, 210b, and/or 210c have uniform dimensions (e.g., lengths, widths, and/or thicknesses) with one another and with corresponding plates 210a, 210b, and/or 210c of the other cryoracks 105. As discussed in greater detail below, the rectangular shapes and/or dimensions of the plates 210a, 210b, and 210c can facilitate positioning and storing the cryoracks 105 in a cryorack holder 120 (FIG. 1) and/or in a liquid nitrogen storage rack. For example, the plates 210a, 210b, and/or 210c of a cryorack 105 can be dimensioned and/or offset from one another (e.g., using standoffs 206) such that the cryorack 105 has outer dimensions (e.g., a length, a width, and/or a height) that are same or generally similar to outer dimensions of conventional cryopreservation storage boxes. This can facilitate (a) positioning the cryoracks 105 within a conventional liquid nitrogen storage rack and/or (b) transferring a cryorack 105 from a controlled-rate freezer directly into a liquid nitrogen storage container (or vice versa) without first requiring a user to transfer cryovials 103 between (i) a storage container or rack configured for only the controlled-rate freezer and (ii) a separate storage container or rack configured only for the liquid nitrogen storage container. Additionally, or alternatively, the rectangular shapes and/or uniform sizes of the plates 105a, 105b, and/or 105c of the cryoracks 105 can facilitate (a) storing a cryorack 105 in any one of a number of slots in the cryorack holder or in the liquid nitrogen storage rack, and/or (b) storing cryoracks 105 configured to carry different sizes of cryovials 103 in a same cryorack holder 120 or liquid nitrogen storage rack.

In other embodiments, the plates 210a, 210b, and/or 210c of one or more cryoracks 105 can have general shapes (e.g., circular, triangular, pentagonal, hexagonal, octagonal, etc.) that are non-rectangular. Additionally, or alternatively, the dimensions of the plates 210a, 210b, and/or 210c of a cryorack 105 can vary from one another and/or from corresponding plates 210a, 210b, and/or 210c of other cryoracks 105. For example, a bottom plate 210b of a cryorack 105 can have a larger or smaller length, width, and/or thickness than (a) a length, width, and/or thickness, respectively, of a top plate 210a and/or a middle plate 210c of the cryorack 105 and/or (b) a length, width, and/or thickness, respectively, of a bottom plate 210b of another cryorack 105. As another example, a top plate 210a of a cryorack 105 can have a larger or smaller length, width, and/or thickness than (a) a length, width, and/or thickness, respectively, of a bottom plate 210b and/or a middle plate 210c of the cryorack 105 and/or (b) a length, width, and/or thickness, respectively, of a top plate 210b of another cryorack 105.

As discussed above, the cryoracks 105 are configured to carry or store an array of cryovials 103. In this regard, the top plates 210a illustrated in FIG. 2 each include a plurality of openings 212a (e.g., holes, slots, apertures, voids, etc.) shaped and sized to receive a cryovial 103 of a particular size/diameter. For example, the top plate 210a of the cryorack 105d includes openings 212a that are each configured to receive a 1.8-mL cryovial 103. As additional examples, the top plate 210a of the cryorack 105a includes openings 212a that are each configured to receive a 10-mL closed cryovial 103; the top plate 210a of the cryorack 105b includes openings 212a that are each configured to receive a 20-mL closed cryovial 103; the top plate 210a of the cryorack 105c includes openings 212a that are each configured to receive a 50-mL closed cryovial 103; the top plate 210a of the cryorack 105e includes openings 212a that are each configured to receive a 2-mL closed cryovial 103; and the top plate 210a of the cryorack 105f includes openings 212a that are each configured to receive a 6-mL closed cryovial 103. In some embodiments, the closed cryovials 103 can be ready-to-fill closed vials, such as AT-Closed Vials® manufactured by Aseptic Technologies of Gembloux, Belgium. Other shapes and sizes of openings 212a (e.g., corresponding to the shapes and sizes of the cryovials 103 of the above examples and/or to other shapes and sizes of other cryovials 103) are of course possible and within the scope of the present technology. When a cryovial 103 is positioned within an opening 212a, the opening 212a can limit lateral movement of the cryovial 103 to facilitate maintaining the cryovial 103 in a generally vertical orientation.

The bottom plates 210b illustrated in FIG. 2 each similarly include a plurality of openings 212b. The openings 212b can be shaped and sized to receive a bottom portion of a cryovial 103 that can be received in a corresponding opening 212a of a corresponding top plate 210a. Thus, the diameters of the openings 212b in the bottom plates 210b can be the same or smaller than the diameters of the corresponding openings 212a in the top plates 210a. In these embodiments, when an opening 212b in a bottom plate 210b receives a bottom portion of the cryovial 103, the bottom plate 210b can limit vertical and/or horizontal motion of the cryovial 103, thereby stabilizing the cryovial 103 within the cryorack 105 and retaining a generally vertical orientation of the cryovial 103. Other shapes and sizes of openings 212b are of course possible and within the scope of the present technology.

As shown, the bottom plates 210b of the cryoracks 105a-105f include a same number of openings 212b as the number of openings 212a in the corresponding top plates 210a. In other embodiments, the bottom plates 210b can include a greater or lesser number of openings 212b than the number of openings 212a included in the corresponding top plate 210a. For example, a bottom plate 210b can lack openings 212b in some embodiments such that the bottom plate 210b serves as a tray. Continuing with this example, the bottom plate 210b can include notches or indentation features to help stabilize and retain a cryovial 103 in a generally vertical orientation within the cryorack 105. In these and other embodiments, the shapes of the openings 212b can be non-circular and/or can differ from the shapes of the openings 212a in the corresponding top plate 210a.

In cryoracks 105 having one or more middle plates 210c, the middle plate(s) 210ccan include a plurality of openings 212c. The openings 212c can be shaped and sized to receive a bottom and/or middle portion of a cryovial 103 that can be received in a corresponding opening 212a of a corresponding top plate 210a. Thus, the diameters of the openings 212c in the middle plates 210c can be the same or different from (e.g., smaller or larger than) the diameters of the corresponding openings 212a in the top plates 210a. When a cryovial 103 is positioned within an opening 212c, the opening 212c can limit lateral movement of the cryovial 103 to facilitate maintaining the cryovial 103 in a generally vertical orientation. As such, the middle plate(s) 210c can facilitate stabilizing (e.g., tall) cryovials 103 positioned within the cryorack 105. In these and other embodiments, the shapes of the openings 212c can be non-circular and/or can differ from the shapes of the corresponding openings 212a in the corresponding top plate 210a and/or from the shapes of the corresponding openings 212b in the corresponding bottom plate 210b.

Although each of the plates 210a, 210b, and 210c of the cryoracks 105 of FIG. 2 are illustrated with a specific number of openings 212a, 212b, and/or 212c, respectively, the plates 210a, 210b, and/or 210c can include a greater or lesser number of openings 212a, 212b, and/or 212c, respectively, in other embodiments. Additionally, or alternatively, the openings 212a, 212b, and/or 212c can be positioned at different locations and/or arranged in different patterns on the plates 210a, 210b, and 210c, respectively. For example, the openings 212a, 212b, and/or 212c can be arranged in a circular, spiral, quincunx, or other (e.g., non-perfect square) pattern. Furthermore, although the openings 212a, 212b, and 212c of each plate 210a, 210b, and 210c, respectively, are illustrated with uniform shapes and sizes, the shapes and sizes of the openings 212a, 212b, and/or 212c of each plate 210a, 210b, and/or 210c, respectively, can vary in other embodiments. For example, the openings 212a of a top plate 210a can include both circular and non-circular openings 212a. Additionally, or alternatively, the openings 212a of the top plate 210a can include a first opening 212a of a first size (e.g., a first diameter) and a second opening 212a of a second, larger size (e.g., a second, larger diameter). The different shaped and/or sized openings 212a of the top plate 210a can enable the corresponding cryorack 105 to carry and/or store differently shaped and/or sized cryovials 103 at the same time.

The openings 212a, 212b, and/or 212c can be formed in the top plates 210a, the bottom plates 210b, and/or the middle plates 210c, respectively, using various manufacturing techniques. For example, the openings 212a, 212b, and/or 212c can be formed by drilling the top plates 210a, the bottom plates 210b, and/or the middle plates 210c, respectively. Additionally, or alternatively, the openings 212a, 212b, and/or 212c can be formed using other manufacturing techniques, such as three-dimensional printing or injection molding.

As discussed in greater detail below, the open framework of the cryoracks 105 (provided at least in part by (a) the openings 212a, 212b, and/or 212c, and/or (b) the spacing between the plates 210a, 210b, and/or 210c) can expose cryovials 103 carried by or stored within the cryoracks 105 to air or another cooling medium and/or can permit the air or the other cooling medium to flow through at least a portion of the cryoracks 105. Thus, in comparison with other cryopreservation storage racks or containers (e.g., cryopreservation storage boxes), the cryoracks 105 are expected to improve the flow of air or another medium (a) through the cryoracks 105 and/or (b) throughout a controlled-rate freezer, liquid nitrogen storage container, or another cryopreservation instrument in which the cryoracks 105 are positioned. In turn, the improved flow of air or another medium is expected to (a) improve heat exchange with biological material stored in a cryovial 103 positioned within the cryorack 105, and/or (b) provide a greater amount of control over and/or uniformity of cooling/freezing the biological material. Furthermore, the open framework of the cryoracks 105 can provide ready access to individual cryovials 103 positioned within a cryorack 105. This can enable retrieval of individual cryovials 103 from a liquid nitrogen archiving system.

Moreover, as discussed in greater detail below, the cryoracks 105 (a) can be dimensioned to fit within a cryorack holder (e.g., the cryorack holder 120 of FIG. 1) that can be installed within a controlled-rate freezer and (b) can be dimensioned to fit within a liquid nitrogen storage rack that can be installed within a liquid nitrogen storage container. This can enable the cryoracks 105 (and the cryovials 103 positioned within the cryoracks 105) to be directly transferrable between a controlled-rate freezer and a liquid nitrogen storage container without transferring cryovials 103 between storage racks or containers dimensioned for only the controlled-rate freezer or for only the liquid nitrogen storage container. Thus, the cryoracks 105 of the present technology are expected to (a) decrease the amount of time required to transfer cryovials 103 between a controlled-rate freezer and a liquid nitrogen storage container, (b) reduce the risk of damaging or otherwise compromising the integrity of biological material stored within the cryovials 103 during the transfer, and (c) maintain a generally constant temperature of the biological material during the transfer.

FIG. 3 is a partially schematic, perspective view of a cryorack holder 120 configured in accordance with various embodiments of the present technology. As shown, the cryorack holder 120 has a similar structure to the structure of the cryoracks 105 (e.g., the cryorack 105d) of FIG. 2. For example, the cryorack holder 120 includes a top plate or shelf 330a, a bottom plate or shelf 330b, and a plurality of standoffs 326 separating the top shelf 330a from the bottom shelf 330b. Each standoff 326 includes a body portion 327, a center rod 328, and one or more retention mechanisms 329. The cryorack holder 120 further includes a middle plate or shelf 330c (a) positioned between the top shelf 330a and the bottom shelf 330b and (b) separated from the top and bottom shelves 330a and 330b by first and second portions 327a and 327b of the body portion 327 of the corresponding standoffs 326. Although shown with three shelves 330 in FIG. 3, cryorack holders 120 configured in accordance with other embodiments of the present technology can include a greater (e.g., four or more) or lesser (e.g., two or one) number of shelves 330. For example, a cryorack holder 120 of the present technology can include multiple middle shelves 330c in addition to a top shelf 330a and a bottom shelf 330b.

In some embodiments, the top shelves 330a, the bottom shelves 330b, the middle shelves 330c, and the standoffs 326 can be formed of one or more suitable materials that maintain integrity at cryogenic temperatures. For example, the top shelves 330a, the bottom shelves 330b, the middle shelves 330c, the body portions 327, the center rods 328, and/or the retention mechanisms 329 can be formed of one or more metals, glasses, and/or thermoplastics (e.g., polypropylene, polycarbonate, etc.). In the illustrated embodiment, each component of the cryorack holder 120 is formed of one or more metallic materials.

As shown, the body portion 327 of a standoff 326 is generally cylindrical. In other embodiments, the body portion 327 of the standoff 326 can have a different general shape (e.g., block, pentagonal, hexagonal, octagonal, etc.). In some embodiments, the body portion 327 can include flat or machined portions or surfaces to facilitate (i) turning the body portion 327 or (ii) holding the body portion 327 in place (e.g., using a wrench or another tool). In these and other embodiments, the body portion 327 and/or the retention mechanism 329 can be sized and/or shaped to facilitate assembling the standoff 326 and/or the cryorack holder 120 via hand-tightening and/or without the use of tools. The body portion 327 can include a first body portion 327a and a second body portion 327b. In some embodiments, the first body portion 327a is a separate component from the second body portion 327b. In other embodiments, the first body portion 327a and the second body portion 327b can be a single, integrated component. The first body portion 327a can be positioned between the top shelf 330a and the middle shelf 330c and can serve as a spacer to offset the top shelf 330a away from the middle shelf 330c by a first distance. The second body portion 327b can be positioned between the bottom shelf 330b and the middle shelf 330c and can serve as a spacer to offset the bottom shelf 330b from the middle shelf 330c by a second distance. In the illustrated embodiment, the first distance and the second distance are equivalent. In other embodiments, the first distance and the second distance can differ, with either of the first and the second distances being greater than the other of the first and second distances. In some embodiments, the first and second distances can correspond at least in part to heights of cryoracks 105 and/or 205 that can be positioned in and carried by the cryorack holder 120 (as discussed in greater detail below).

The center rod 328 of each standoff 326 can be similar to the center rod 208 of the cryoracks 105 of FIG. 2. For example, the center rod 328 of FIG. 3 can pass through a center of the body portion 327, can include one or more threaded ends configured to receive one or more retention mechanisms 329, and/or can include threading on a center portion that can interface with corresponding threading on an interior of the body portion 327. In some embodiments, the center rod 328 has a larger length than the length of the body portion 327 such that the center rod 328 protrudes beyond the ends of the body portion 327 when the center rod 328 is installed within the body portion 327. Alternatively, the body portion 327 and the center rod 328 can be a single, integrated component such that the body portion 327 includes ends that form the center rod 328 and that protrude outward from the cylindrical center portion of the body portion 327 in each direction. In some embodiments, the center rod 328 can be a bolt or a screw having, for example, a hexagonal- or other-shaped head at one end and a threaded end at the other end. Alternatively, the center rod 328 can lack a head (e.g., similar to a set screw).

The center rod 328 can extend through the body portion 327, the top shelf 330a, the bottom shelf 330b, and/or the middle shelf 330c. In this regard, the top shelf 330a, the bottom shelf 330b, and/or the middle shelf 330c can include openings sized to allow the center rod 328 to extend therethrough. As the center rod 328 receives the retention mechanism(s) 329 at its end(s), the center rod 328 and the retention mechanism 329 (a) can clamp (e.g., cinch, pull, etc.) the shelves 330a, 330b, and/or 330c toward one another and/or against the body portion 327 of the standoff 326 and (b) can limit motion of the shelves 330a, 330b, and/or 330c along an axis of the center rod 328. When (i) the body portion 327 is positioned between the shelves 330a, 330b, and/or 330c; (ii) the center rod 328 is extended through the body portion 327 and/or the shelves 330a, 330b, and/or 330c; and (iii) the retention mechanism(s) 329 is/are installed on the end(s) of the center rod 328, the standoffs 326 can retain the shelves 330a, 330b, and/or 330c against the body portion 327 and/or in the stacked arrangement or configuration illustrated in FIG. 3. In embodiments in which the center rod 328 includes a head, the head can similarly be used to retain the shelves 330a, 330b, and/or 330c against the body portion 327 and/or in the stacked arrangement.

Four standoffs 326 are used in FIG. 3 to position and hold the shelves 330a, 330b, and/or 330c of the cryorack holder 120 in the stacked arrangement. A different number (e.g., three or less, or five or more) of standoffs 326 can be used in other embodiments. For example, the cryorack holder 120 can include (a) four standoffs 326 that are used to retain the bottom shelf 330b and the center shelf 330c in the stacked arrangement, and (b) four (or a different number of) additional/separate standoffs 326 that are used to retain the middle shelf 330c and the top shelf 330a in the stacked arrangement. Continuing with this example, the standoffs 326 holding the middle shelf 330c to the bottom shelf 330b may or may not be vertically aligned with the standoffs 326 holding the middle shelf 330c to the top shelf 330a.

The standoffs 326 of the cryorack holder 120 in FIG. 3 are positioned along a perimeter and at corners of the cryorack holder 120. In other embodiments, the standoffs 206 can be positioned at other locations within the cryorack holder 120. The positioning of the standoffs 326 in the cryorack holder 120 can facilitate a generally uniform weight distribution across the cryorack holder 120 (e.g., when the cryorack holder 120 is empty of cryoracks and/or when the cryorack holder 120 is filled with cryoracks).

FIG. 3A is a partially schematic, exploded view of another cryorack holder 320 configured in accordance with various embodiments of the present technology. The cryorack holder 320 is similar to the cryorack holder 120 of FIG. 3. For example, the cryorack holder 320 includes a top shelf 330a, a bottom shelf 330b, and a middle shelf 330c separated from one another and held in a stacked arrangement via use of a plurality of standoffs 326A. In contrast to the standoffs 326 of FIG. 3 that use center rods 328 that extend through the top shelf 330a, the bottom shelf 330b, and the middle shelf 330c, the standoffs 326A of FIG. 3A each include a plurality of body portions 327 (identified individually in FIG. 3A as body portions 327A-327F), a first retention mechanism 329A, a second retention mechanism 329B, and a connecting rod 325 that are used to assemble the cryorack holder 320. More specifically, each of the body portions 327 include (a) a threaded nub at a first end portion and (b) corresponding threading within an interior of the body portion 327 at a second end portion that is configured to interface with a threaded nub of another body portion 327. The threaded nubs on the body portions 327B and 327C and the corresponding threading within the interiors of the body portions 327A and 327B facilitate connecting the body portions 327A-327C to one another. Similarly, the threaded nubs on the body portions 327D and 327E and the corresponding threading within the interiors of the body portions 327E and 327F facilitate connecting the body portions 327D-327F to one another. The threaded nub of the body portion 327A can extend through an opening 314a in the top shelf 330a and be received by corresponding threading within an interior of the first retention mechanism 329A. Similarly, the threaded nub of the body portion 327F can extend through an opening 314b in the bottom shelf 330b and be received by corresponding threading within an interior of the second retention mechanism 329B. The connecting rod 325 of the standoff 326A can be threaded and be configured to extend through an opening 314c in the middle shelf 330c. Corresponding threading within the interior of the body portion 327C and corresponding threading within the interior of the body portion 327D can interface with threading on respective ends of the connecting rod 325.

As the various components of the standoff 326A are connected to one another during assembly of the cryorack holder 320, the standoff 326A can (a) clamp (e.g., cinch, pull, etc.) the shelves 330a-330c toward one another and/or against the body portions 327A-327F of the standoff 326A, (b) limit motion of the shelves 330a-330c along a center axis of the standoff 326A, and (c) hold the shelves 330a-330c in a stacked arrangement. In some embodiments, the various components of a standoff 326A can be hand tightened to one another to, for example, assemble the cryorack holder 320. Additionally, or alternatively, one or more of the body portions 327, the first retention mechanism 329A, and the second retention mechanism 329B of a standoff 326A can be shaped and/or sized such that tools (e.g., a wrench) can be used to tighten the connection of the body portions 327, the retention mechanisms 329A and 329B, and the connecting rod 325 to one another.

The different body portions 327 of a standoff 326A can be the same size or can vary from one another. For example, different body portions 327 of a standoff 326A can have the same or different lengths. The different body portions 327 of a standoff 326A can facilitate (a) connecting any number of shelves of a cryorack holder 320 to one another, and/or (b) achieving different distances of separation between the shelves (e.g., between the top shelf 330aand the middle shelf 330c, between the top shelf 330a and the bottom shelf 330b, and/or between the middle shelf 330c and the bottom shelf 330b) of a cryorack holder 320 by varying the number of different body portions 327 and/or the lengths of the different body portions 327 of a standoff 326A. Although shown with a plurality of body portions 327 between each pair of immediately adjacent shelves 330 of the cryorack holder 320 in FIG. 3A, standoffs 326A configured in accordance with other embodiments of the present technology can include a single body portion 327 between each pair of immediately adjacent shelves 330 of a cryorack holder 320.

Furthermore, although shown with openings 314a, 314b, and 314c in the top, bottom, and middle shelves 330a, 330b, and 330c, respectively, one or more of the openings 314a, 314b, and/or 314c can be slots that extend to the perimeters of the corresponding shelves 330a, 330b, and/or 330c in some embodiments of the present technology. In these embodiments, rather than extending components of a standoff 326A through holes in the shelves 330a, 330b, and/or 330c, components (e.g., the nub of the body portion 327A, the nub of the body portion 327F, and/or the connecting rod 325) can be slid or rotated into corresponding slots in the shelves 330a, 330b, and/or 330c. As the components of the standoff 326A are tightened to one another, the vertical clamping force provided by the standoff 326A can prevent the components of the standoff 326A from slipping or rotating out of the slots in the shelves 330a, 330b, and/or 330c.

Other methods of assembling the cryorack holder 120 and/or the cryorack holder 320 of FIGS. 3 and 3A are of course possible and within the scope of the present technology. For example, standoffs similar to the standoffs 206A illustrated in FIG. 2A and discussed in detail above can be used to assemble a cryorack holder in some embodiments of the present technology. As another example, welds or other fasteners or connectors (e.g., rivets, snap fits, snap button connectors, magnets, brad-like connectors, etc.) can be used to connect various portions of the cryorack holders 120 and/or 320 together. As a specific example, the top shelf 330a, the bottom shelf 330b, and/or the middle shelf 330c can be welded to standoff structures (e.g., in addition to or in lieu of being clamped to the standoff structures using nuts, bolts, threading, other fasteners, etc.). Additionally, or alternatively, the top shelf 330a, the bottom shelf 330b, and/or the middle shelf 330c may or may not include openings or slots sized to allow a center rod 208, threaded nubs, connecting rods 325, or other assembly components to extend therethrough. For example, a top shelf 330a can be welded to a standoff structure at a bottom surface of the top shelf 330a such that the standoff structure does not extend through the top shelf 330a to a top surface of the top shelf 330a. As another example, a top shelf 330a can be welded to a standoff structure at a top surface of the top shelf 330a, and/or a bottom shelf 330b can be welded to a standoff structure at a bottom surface of the bottom shelf 330b. More specifically, at least a portion of the standoff structure can extend through an opening in the top shelf 330a and/or through an opening in the bottom shelf 330b, and the top shelf 330a and/or the bottom shelf 330b can be welded to a portion of the standoff structure at the top surface of the top shelf 330a and/or at the bottom surface of the bottom shelf 330b. As still another example, a bottom shelf 330b can be welded to a standoff structure at a top surface of the bottom shelf 330b such that the standoff structure does not extend through the bottom shelf 330b to a bottom surface of the bottom shelf 330b. Continuing with this example, one or more separate feet or protrusion components can be welded or otherwise fastened to the bottom surface of the bottom shelf 330b, or the bottom surface of the bottom shelf 330b can include feet or protrusion structures that are integrated with the bottom shelf 330b. Alternatively, the bottom surface of the bottom shelf 330b can lack feet or protrusion components (e.g., such that the bottom surface of the bottom shelf 330b can sit flush on a supporting surface).

Referring again to FIG. 3, the top shelf 330a, the bottom shelf 330b, and/or the middle shelf 330c of the cryorack holder 120 in FIG. 3 are generally rectangular shaped. Additionally, the shelves 330a, 330b, and/or 330c have uniform dimensions (e.g., lengths, widths, and/or thicknesses). As discussed in greater detail below, the rectangular shapes and/or dimensions of the shelves 330a, 330b, and 330c can facilitate positioning the cryorack holder 120 in a controlled-rate freezer and/or in another cryopreservation instrument.

In other embodiments, the shelves 330a, 330b, and/or 330c of the cryorack holder 120 can have general shapes (e.g., circular, triangular, pentagonal, hexagonal, octagonal, etc.) that are non-rectangular. Additionally, or alternatively, the dimensions of the shelves 330a, 330b, and/or 330c of the cryorack holder 120 can vary from one another. For example, the bottom shelf 330b can have a larger or smaller length, width, and/or thickness than a length, width, and/or thickness, respectively, of the top shelf 330a and/or the middle shelf 330c. As another example, the top shelf 330a can have a larger or smaller length, width, and/or thickness, respectively, than a length, width, and/or thickness of the middle shelf 330c.

As discussed above, the cryorack holder 120 is configured to carry or store an array of cryoracks 105 and/or 205. In this regard, each of the shelves 330 illustrated in FIG. 3 include a plurality of openings 332 (e.g., holes, slots, apertures, voids, etc.) shaped and sized to correspond to shapes and sizes of cryoracks 105 and/or 205 that can be positioned in the cryorack holder 120. In some embodiments, an area of an opening 332 can be less than an area of a bottom surface of a bottom plate 210b of a cryorack 105 and/or 205. As such, each of the shelves 330 of the cryorack holder 120 can serve as a shelf and provide vertical support to one or more cryoracks 105 and/or 205 (e.g., at least about a perimeter of the openings 332) when the one or more cryoracks 105 and/or 205 are installed within the cryorack holder 120.

Each of the shelves 330 can further include openings 334 positioned about a perimeter and/or at corners of each of the openings 332. The openings 334 can be configured to receive protrusions 215 (FIG. 2) and/or 215A (FIG. 2A) of a cryorack 105 and/or 205. As discussed above with respect to FIGS. 2 and 2A, protrusions 215, 215A of a cryorack 105, 205 can be formed at least in part by bottom portions of standoffs 206 and/or 206A and can be positioned about (e.g., at, along, proximate, etc.) a perimeter and/or at corners of a bottom surface of the bottom plate 210b of the cryorack 105, 205. For a cryorack 105, 205 having protrusions 215, 215A about a perimeter and/or at corners of the bottom plate 210b, the cryorack 105, 205 can be installed within the cryorack holder 120 by positioning the cryorack 105, 205 above an opening 332 in one of the shelves 330 of the cryorack holder 120 and by lowering the cryorack 105, 205 toward the opening 332 while the protrusions 215, 215A of the cryorack 105, 205 are inserted into (e.g., positioned within, snagged into, dropped into, slid into, extended through, etc.) corresponding ones of the openings 334 about the perimeter of the opening 332. For example, protrusions 215, 215A of the cryorack 105, 205 can be positioned on a shelf 330 of the cryorack holder 120, and the cryorack 105, 205 can be slid along the shelf 330 until the cryorack 105, 205 is positioned over an opening 332 in the shelf 330 and the protrusions 215, 215A snag or drop into corresponding openings 334 in the shelf 330. When the protrusions 215, 215A of the cryorack 105, 205 are installed in the openings 334 of the cryorack holder 120, the sides of the openings 334 of the shelf 330 can limit lateral movement of the cryorack 105, 205 with respect to the top surface of the corresponding shelf 330 (e.g., at least when the protrusions 215, 215A of the cryorack 105, 205 abut against the sides of the openings 334).

As discussed above with respect to FIG. 2, the protrusions 215, 215A of some cryoracks 105, 205 can be positioned closer to a center of the bottom plates 210b of the cryoracks 105, 205 (e.g., as opposed to about a perimeter of the bottom plates 210b), similar to the protrusions 215 of the cryorack 105a of FIG. 2. For example, the protrusion 215, 215A of a cryorack 105, 205 can be positioned at least a tenth of the way, an eighth of the way, a quarter of the way, a third of the way, halfway, or more of the way from the perimeter of the cryorack 105, 205 to the center of the cryorack 105, 205. For a cryorack 105, 205 having protrusions 215, 215A nearer the center of the bottom plate 210b, the cryorack 105, 205 can be installed within the cryorack holder 120 by positioning the cryorack 105, 205 above an opening 332 in one of the shelves 330 of the cryorack holder 120 and by lowering the cryorack 105, 205 toward the opening 332 while the protrusions 215, 215A of the cryorack 105, 205 are inserted into (e.g., positioned within, snagged into, dropped into, slid into, extended through, etc.) the opening 332 (e.g., as opposed to the openings 334) in the shelf 330. For example, protrusions 215, 215A of the cryorack 105, 205 can be positioned on a shelf 330 of the cryorack holder 120, and the cryorack 105, 205 can be slid along the shelf 330 until the protrusions 215, 215A drop into an opening 332 of the shelf 330 and the cryorack 105, 205 is positioned over the opening 332. When the protrusions 215, 215A of the cryorack 105, 205 are installed in the opening 332, the sides of the openings 332 can limit lateral movement of the cryorack 105, 205 with respect to the top surface of the corresponding shelf 330 (e.g., at least when the protrusions 215, 215A of the cryorack 105, 205 abut against the sides of the opening 332).

Thus, the openings 332 and the openings 334 of the cryorack holder 120 facilitate positioning and retaining any one of a number of cryoracks 105, 205 within the cryorack holder 120 regardless of, for example, the arrangement of the protrusions 215, 215A of a cryorack 105, 205 and/or the size of cryovials 103 the cryorack 105, 205 is configured to carry. In other words, multiple different sizes of cryovials 103 and/or multiple different configurations of cryoracks 105, 205 can be carried by and/or stored within the cryorack holder 120 (e.g., at the same time) using the openings 332 and 334. Furthermore, in the embodiment illustrated in FIG. 3, the shelves 330 are uniform, and the shape, size, positioning, and layout the openings 332 and the openings 334 are uniform. Therefore, in this embodiment, a cryorack 105, 205 can be installed in the cryorack holder 120 over any one of the openings 332 regardless of, for example, the arrangement of the protrusions 215, 215A of a cryorack 105, 205 and/or the size of cryovials 103 the cryorack 105, 205 is configured to carry.

Although each shelf 330 of the cryorack holder 120 is illustrated with four openings 332 and sixteen openings 334 in FIG. 3, a shelf 330 of the cryorack holder 120 can include a greater or lesser number of openings 332 and/or 334 in other embodiments. Furthermore, the layout and/or positioning of the openings 332 and/or 334 on a shelf 330 can differ from the layouts and/or positionings illustrated in FIG. 3. In addition, other shapes (e.g., non-rectangular and/or non-circular) and sizes of openings 332 and/or openings 334 are of course possible and within the scope of the present technology. Moreover, the number, shape, size, and/or layout of the openings 332 and/or the openings 334 can vary across a single shelf 330 of a cryorack holder 120 and/or across any two shelves 330 of the cryorack holder 120. For example, the top shelf 330a of the cryorack holder 120 can (a) include a greater or lesser number of openings 332 and/or openings 334 than illustrated in the top shelf 330a of FIG. 3, (b) include openings 332 and/or 334 of different shapes and/or sizes than shown in the top shelf 330a of FIG. 3, and/or (c) include a greater or lesser number of openings 332 and/or openings 334 than the bottom shelf 330b and/or the middle shelf 330c.

The openings 332 and/or the openings 334 can be formed in the top shelf 330a, the bottom shelf 330b, and/or the middle shelf 330c using various manufacturing techniques. For example, the openings 332 and/or the openings 334 can be formed by drilling the top shelf 330a, the bottom shelf 330b, and/or the middle shelf 330c. Additionally, or alternatively, the openings 332 and/or the openings 334 can be formed using other manufacturing techniques, such as three-dimensional printing or injection molding.

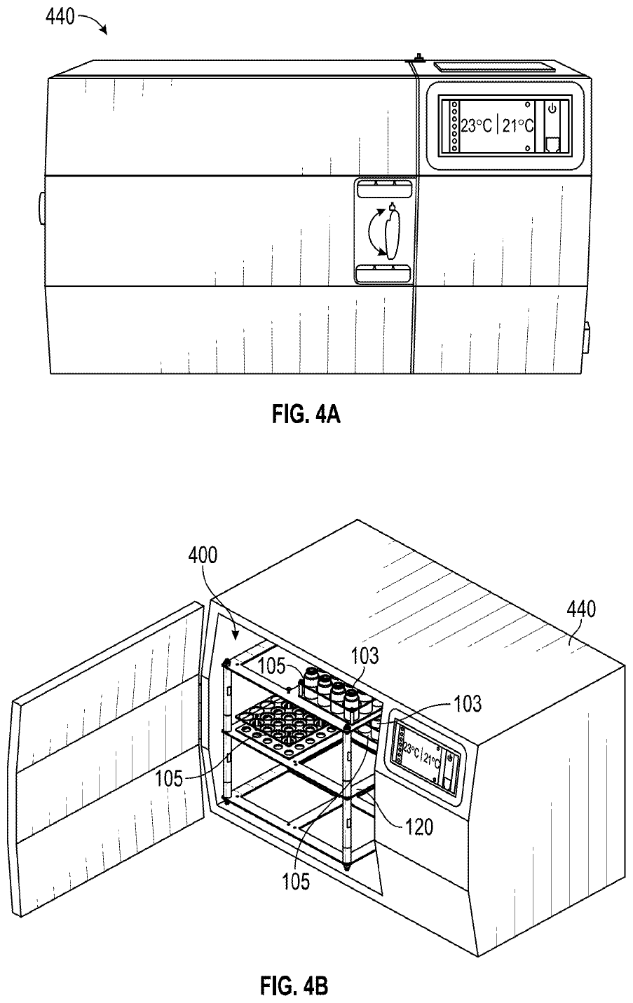

In some embodiments, the cryorack holder 120 can be dimensioned to fit within a cryopreservation instrument. In this regard, the shelves 330 and the standoffs 326 can be dimensioned with lengths, widths, and/or thicknesses/heights such that the cryorack holder 120 (when assembled) has an overall length, width, and/or height that fits within an interior of the cryopreservation instrument. As a specific example, FIG. 4A is a partially schematic, perspective view of a controlled-rate freezer 440 configured in accordance with various embodiments of the present technology, and FIG. 4B is a partially schematic, front view of a cryogenic storage rack system 400 (“the system 400”) installed in the controlled-rate freezer 440 of FIG. 4A. The system 400 includes a cryorack holder 120 and a plurality of cryoracks 105 positioned within (e.g., stored in, loaded in, carried by, etc.) the cryorack holder 120. As shown in FIG. 4B, the cryorack holder 120 is dimensioned such that it fits inside the controlled-rate freezer 440. The cryoracks 105 can be installed in the cryorack holder 120 before, during, and/or after loading the cryorack holder 120 into the controlled-rate freezer 440; and cryovials 103 can be positioned within the cryoracks 105 before, during, and/or after loading one or more of the cryoracks 105 into the cryorack holder 120. In this manner, biological material stored within the cryovials 103 can be stored within the controlled-rate freezer 440 (e.g., for cooling the biological material to cryogenic temperatures) using the cryoracks 105 and the cryorack holder 120 of the system 400.

Similar to the cryoracks 105, 205 discussed above, the open framework of the cryorack holder 120 (provided at least in part by (a) the openings 332, (b) the openings 334, and/or (c) the spacing between the shelves 330a, 330b, and/or 330c of the cryorack holder 120) can provide ready access to individual cryovials 103 stored in a cryorack 105, 205 that is positioned within the cryorack holder 120. Additionally, or alternatively, the open framework of the cryorack holder 120 can expose cryovials 103 positioned within the cryorack holder 120 to air or another cooling medium (e.g., in a cryopreservation instrument) and/or can permit the air or the other cooling medium to flow through at least a portion of the cryorack holder 120. Thus, cryorack holders 120 of the present technology are expected to improve the flow of air or another medium (a) through the cryorack holders 120, and/or (b) throughout a controlled-rate freezer or another instrument in which the cryorack holders 120 are positioned. In turn, the improved flow of air or another medium is expected to (a) improve heat exchange with biological material stored in a cryovial 103 positioned within the cryorack holder 120, and/or (b) provide a greater amount of control over and/or uniformity of cooling/freezing the biological material.

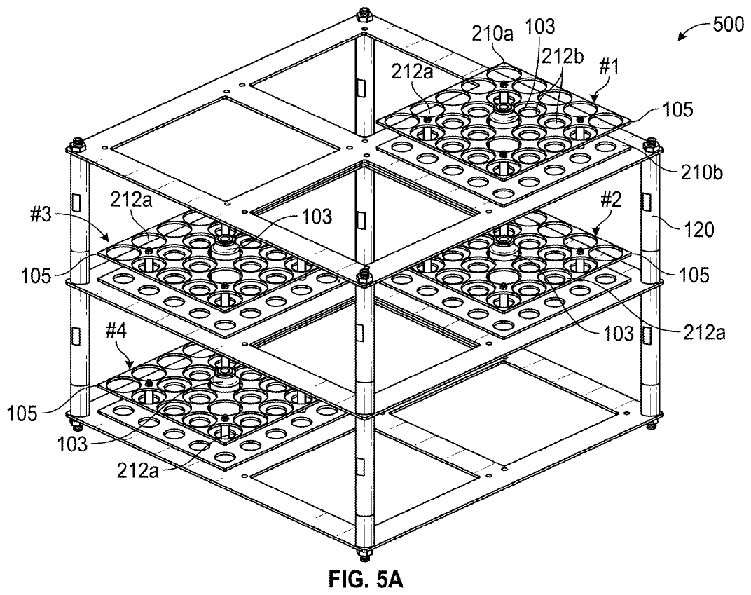

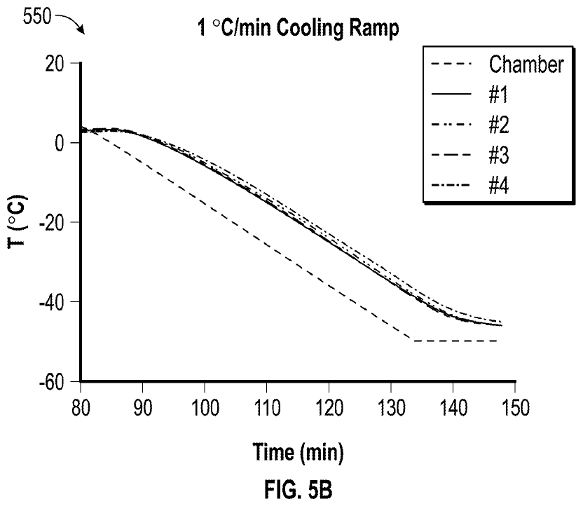

For example, FIG. 5A is a partially schematic, perspective view of a cryogenic storage rack system 500 (“the system 500”) configured in accordance with various embodiments of the present technology. The system 500 includes four cryoracks 105 installed in four different positions within a cryorack holder 120. To illustrate (a) the improved air flow, (b) the improved heat exchange with biological material, and (c) the improved control over and uniformity of cooling/freezing biological material using the present technology, a 10-mL closed cryovial 103 containing 5 mL of 70% ethanol was positioned in center openings 212a and 212b of the top plates 210a and the bottom plates 210b, respectively, of each of the cryoracks 105 of the system 500. The system 500 was positioned into a controlled-rate freezer, and a plurality of temperature sensors were used to capture temperature readings of the ethanol in each of the cryovials 103 and of the interior of the controlled-rate freezer while the ethanol was subjected to a one-degree Celsius cooling ramp and (b) a 25-degree Celsius cooling ramp. The resulting line plot 550 is provided in FIG. 5B and illustrates temperature over time.

As shown in the line plot 550 of FIG. 5B, when the one-degree Celsius cooling ramp was employed, the temperature of the ethanol at each of the positions decreased (i) at a steady and uniform rate and (ii) in step with the interior of the controlled-rate freezer. This suggests that the open framework of the cryoracks 105 and the cryorack holders 120 of the present technology facilitate a generally uniform distribution or flow of air or another cooling medium throughout the controlled-rate freezer (including throughout the individual cryoracks 105). This also suggests that the open framework of the cryoracks 105 and the cryorack holders 120 of the present technology facilitate a generally uniform heat exchange between biological material and air or another cooling medium regardless of, for example, positioning of the biological material within the system 500 of FIG. 5A and/or positioning of the biological material within the controlled-rate freezer. In other words, the present technology is expected to improve uniformity of cooling across several cryovials 103 stored within a cryorack 105 and/or within a cryorack holder 120 of the present technology.

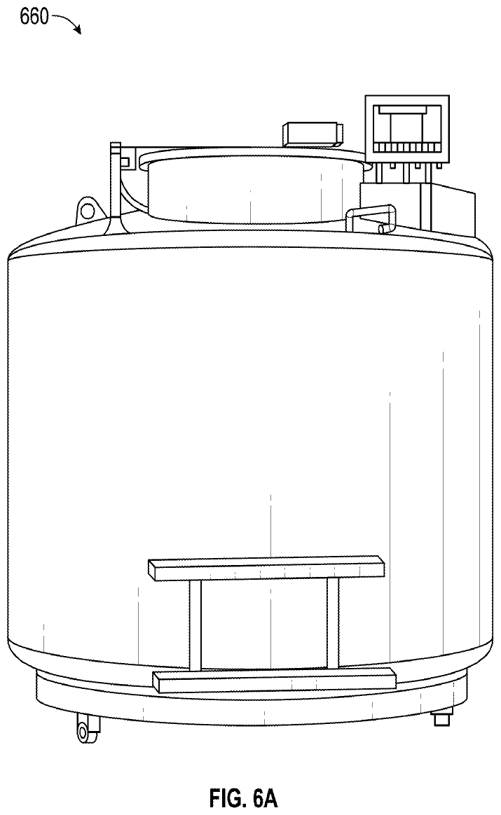

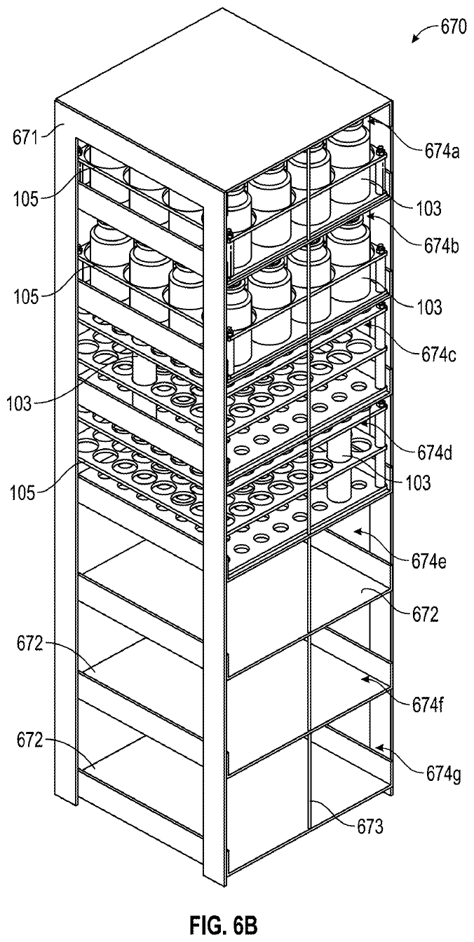

As discussed above with respect to FIG. 2, the cryoracks 105 of the present technology can be dimensioned such that they can be transferred directly from a cryorack holder 120 (e.g., positioned within a controlled-rate freezer) to a liquid nitrogen storage rack (e.g., that can be positioned within a liquid nitrogen storage container), and vice versa. For example, FIGS. 6A and 6B are a partially schematic, perspective views of a liquid nitrogen storage container 660 and a liquid nitrogen storage rack 670, respectively, configured in accordance with various embodiments of the present technology. The liquid nitrogen storage rack 670 is configured such that it can be installed in the liquid nitrogen storage container 660. In the illustrated embodiment, the liquid nitrogen storage rack 670 is a liquid nitrogen storage tower. In some embodiments, the liquid nitrogen storage rack 670 can be a conventional liquid nitrogen storage rack or a liquid nitrogen storage rack custom designed to hold cryoracks 105 of the present technology.

As shown in FIG. 6B, the liquid nitrogen storage rack 670 includes a generally block-shaped frame 671, a plurality of shelves 672, and a retention bar 673. The frame 671 includes a plurality of slots 674 (identified individually as slots 674a-674g in FIG. 6B). The retention bar 673 is removable (at least in part) from the frame 671 such that a cryorack 105 can be positioned in (e.g., slid into) one of the slots 674 and be supported by the corresponding shelf 672. When a cryorack 105 is positioned within one of the slots 674 of the frame 671, the retention bar 673 can be positioned (e.g., repositioned) within the frame 671 and in front of the corresponding slot 674 to limit lateral motion of the cryorack 105 with respect to the corresponding shelf 672 and retain the cryorack 105 within the liquid nitrogen storage rack 670. The cryorack 105 can be inserted into the liquid nitrogen storage rack 670 before, during, or after positioning the liquid nitrogen storage rack 670 within the liquid nitrogen storage container 660 (FIG. 6A).

As discussed above, the cryoracks 105 can be used to carry or store one or more cryovials 103. Additionally, the cryoracks 105 are dimensioned to fit within a cryorack holder 120 that can be positioned within a controlled-rate freezer or another cryopreservation (e.g., cooling) instrument. As such, the cryoracks 105 are dimensioned (a) such that they can be inserted into a controlled-rate freezer (e.g., the controlled-rate freezer 440 of FIG. 4), for example, using a cryorack holder 120 and/or (b) such that they can be inserted into the liquid nitrogen storage container 660 of FIG. 6A, for example, using the liquid nitrogen storage rack 670 of FIG. 6B. Therefore, the cryoracks 105 can be directly transferrable between the controlled-rate freezer and the liquid nitrogen storage container 660 (or vice versa). As a result, cryovials 103 stored in a cryorack 105 and positioned within a controlled-rate freezer can be transferred directly into the liquid nitrogen storage container 660 by removing the cryorack 105 from the controlled-rate freezer and positioning the cryorack 105 in the liquid nitrogen storage container 660. In other words, a user is not required to transfer the cryovials 103 from the cryorack 105 into a specialized storage container, such as a conventional cryopreservation box. Thus, the present technology (a) reduces or minimizes the time that cryovials 103 are outside of a controlled-rate freezer or a liquid nitrogen storage tank as a result of transferring the cryovials 103 between the two cryopreservation instruments, (b) reduces or minimizes temperature fluctuations in biological material stored within the cryovials 103 during transfers between the controlled-rate freezer and the liquid nitrogen storage container, and/or (c) reduces or minimizes a user's handling of the cryovials 103 during the transfer process, each of which reduces or minimizes the risk of damaging or otherwise compromising the integrity of the biological material stored within the cryovials 103.

Moreover, as discussed above, the cryoracks 105 have an open framework that enables a cooling medium to pass through at least a portion of the cryoracks 105. Therefore, when a cryorack 105 is positioned within the liquid nitrogen storage container 660 of FIG. 6A, liquid nitrogen or nitrogen vapor can flow more freely through the liquid nitrogen storage container 660 and/or the cryorack 105, especially in comparison to conventional cryopreservation boxes. In addition, cryovials 103 positioned within the cryorack 105 can each be directly exposed to the liquid nitrogen, thereby improving heat exchange with biological material stored in the cryovials 103, and/or (b) providing a greater amount of control over and/or uniformity of cooling/freezing the biological material. Furthermore, the open framework of the cryorack 105 can provide ready access to individual cryovials 103 positioned within the cryorack 105. This can enable retrieval of individual cryovials 103 from a liquid nitrogen archiving system.

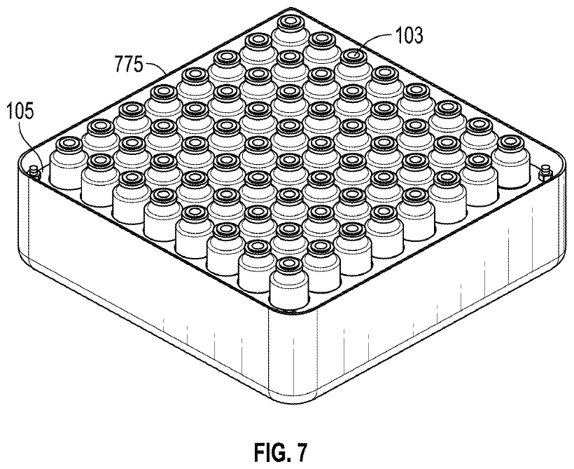

In some embodiments, cryoracks 105 of the present technology can additionally or alternatively be dimensioned to be fit within other storage racks or structures. For example, FIG. 7 is a partially schematic, perspective view of a cryogenic storage rack 105 positioned in a storage box 775 configured in accordance with various embodiments of the present technology. The storage box 775 can be a cryopreservation storage box or another storage box. In embodiments in which the storage box 775 is a cryopreservation storage box, the storage box 775 can be configured to fit within one of the slots 674 of the liquid nitrogen storage rack 670 of FIG. 6B. Continuing with this example, the cryorack 105 can be installed in the cryopreservation storage box 775, the storage box 775 can be inserted into the liquid nitrogen storage rack 670, and the liquid nitrogen storage rack 670 can be installed within the liquid nitrogen storage container 660 of FIG. 6A (e.g., for long-term storage of biological material contained within cryovials 103 positioned in the cryorack 105). The storage box 775 can therefore provide an added layer of physical protection to the cryovials 103 during liquid nitrogen storage.

The storage box 775 can be a conventional cryopreservation storage box. Alternatively, the storage box 775 can be custom designed for use with cryoracks 105 of the present technology. For example, different sizes of storage boxes 775 can be provided, with dimensions of a storage box 775 corresponding, at least in part, to dimensions of a cryorack 105 and/or dimensions (e.g., heights) of the cryovials 103 positioned within the cryorack 105. In some embodiments, the storage box 775 includes a lid (not shown) to, for example, fully enclose the cryorack 105 and/or cryovials 103 positioned in the cryorack 105. In other embodiments, the storage box 775 can lack a lid.

### 2. Associated Methods

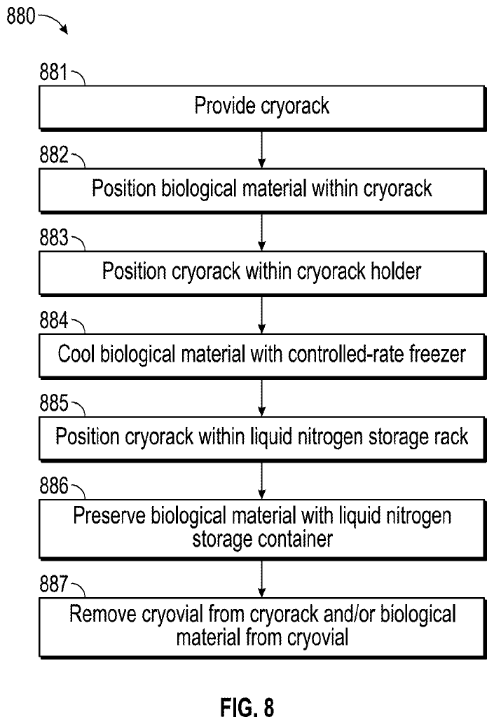

FIG. 8 is a flow diagram illustrating a method 880 of cryopreserving biological material in accordance with various embodiments of the present technology. All or a subset of the steps of the method 880 can be executed by various components or devices of a cryopreservation system of the present technology, such as a cryorack 105, a cryorack holder 120, a cryovial 103, a controller-rate freezer 440, a liquid nitrogen storage container 660, and/or a liquid nitrogen storage rack 670. Additionally, or alternatively, all or a subset of the steps of the method 880 can be executed by a user (e.g., an operator, a technician, an engineer, a patient, etc.) of at least a portion of the cryopreservation system. Furthermore, any one or more of the steps of the method 880 can be executed in accordance with the discussion above.

The method 880 begins at block 881 by providing a cryorack. The cryorack can be any one of the cryoracks 105 discussed above with respect to FIGS. 1-7. Alternatively, the cryorack can be another cryorack configured in accordance with various embodiments of the present technology.

At block 882, the method 880 continues by positioning biological material within the cryorack. The biological material can include organelles, cells, tissues, and/or any other biological constructs. In some embodiments, positioning biological material within the cryorack can include positioning the biological material within a cryovial, such as any one of the cryovials 103 discussed above with respect to FIGS. 1-7 and/or another cryovial configured in accordance with various embodiments of the present technology. Additionally, or alternatively, positioning the biological material within the cryorack can include positioning a cryovial within the cryorack. For example, positioning the cryovial within the cryorack can include inserting the cryovial (e.g., in a generally vertical orientation) into one or more openings formed in plates (e.g., top plates, middle plates, and/or bottom plates) of the cryorack such that the cryorack carries or stores the cryovial by limiting vertical and/or lateral movement of the cryovial while the cryovial is positioned within the cryorack. Positioning the biological material within the cryorack can additionally or alternatively include installing a sensor (e.g., a thermocouple or other sensor) within an interior of the cryorack (e.g., on or in the cryovial).

At block 883, the method 880 continues by positioning the cryorack within a cryorack holder. The cryorack holder can be any one of the cryorack holders 120 discussed above with respect to FIGS. 1-7 and/or another cryorack holder of the present technology. In some embodiments, positioning the cryorack within a cryorack holder includes positioning the cryorack proximate (e.g., above) a first opening in one of the shelves of the cryorack holder, and lowering the cryorack toward the first opening and/or sliding the cryorack across the shelf toward the first opening. Additionally, or alternatively, positioning the cryorack within the cryorack holder can include inserting protrusions on a bottom of the cryorack into the first opening and/or into one or more second openings in the plate positioned proximate (e.g., about the perimeter of, at a corner of, etc.) the first opening.

Positioning the biological material within the cryorack holder can include removing the biological material, cryovial, and/or cryorack from another instrument, such as from a liquid nitrogen storage rack and/or a liquid nitrogen storage container. For example, biological material can be transferred directly from (a) a liquid nitrogen storage rack and/or a liquid nitrogen storage container to (b) the cryorack holder and/or a controlled-rate freezer. Continuing with this example, a cryorack carrying or storing a cryovial containing the biological material can be (a) removed from the liquid nitrogen storage rack and/or the liquid nitrogen storage container and (b) inserted into the cryorack holder that is removably positionable or permanently positioned within a controlled-rate freezer. In other words, a cryovial containing biological material and stored within a cryorack positioned in a liquid nitrogen storage rack and/or a liquid nitrogen storage container can be directly transferred to a cryorack holder and/or a controlled-rate freezer (a) by removing the cryorack from the liquid nitrogen storage rack and/or the liquid nitrogen storage container and positioning the cryorack within the cryorack holder and/or the controlled-rate freezer, and/or (b) without removing the cryovial from the cryorack, without positioning the cryovial within another storage rack configured for or dedicated to only the controlled-rate freezer and/or the cryorack holder, and/or without transferring the biological material to another cryovial (e.g., to a traditional cryovial).

At block 884, the method 880 continues by cooling biological material with a controlled-rate freezer. In some embodiments, cooling the biological material with a controlled-rate freezer can include positioning the biological material within a controlled-rate freezer. For example, cooling the biological material with a controlled-rate freezer can include positioning a cryovial, cryorack, and/or a cryorack holder (e.g., not already positioned within the controlled-rate freezer) into the controlled-rate freezer. The cryovial, cryorack, and/or cryorack holder can be removably positioned within the controlled-rate freezer. Alternatively, the cryorack holder can be permanently positioned within the controlled-rate freezer.

Cooling the biological material with a controlled-rate freezer can include cooling the biological material in accordance with a specified rate. Cooling the biological material with a controlled-rate freezer can include receiving data (e.g., temperature measurements) from a sensor or another electronic device installed within the cryovial, within a cryorack, and/or within the interior or the controlled-rate freezer. Cooling the biological material within the controlled-rate freezer can include cooling the biological material based at least in part on data received from a sensor or the other electronic device installed within the cryovial, cryorack, or controlled-rate freezer.

At block 885, the method 880 continues by positioning the cryorack within a liquid nitrogen storage rack. Positioning the cryorack within a liquid nitrogen storage rack can include sliding or otherwise installing the cryorack into a slot of the liquid nitrogen storage rack. In some embodiments, the liquid nitrogen storage rack can be the cryorack holder of blocks 883 and 884 or another cryorack holder of the present technology. In other embodiments, the liquid nitrogen storage rack can be a storage rack configured for or dedicated to only a liquid nitrogen storage container, such as a conventional liquid nitrogen storage rack. The liquid nitrogen storage rack can be removably or permanently positioned within a liquid nitrogen storage container.

Positioning the cryorack within the liquid nitrogen storage rack can include removing the biological material, cryovial, and/or cryorack from another instrument, such as from a cryorack holder and/or a controlled-rate freezer. For example, biological material can be transferred directly from (a) a cryorack holder and/or a controlled-rate freezer to (b) to the liquid nitrogen storage rack and/or a liquid nitrogen storage container. Continuing with this example, a cryorack carrying or storing a cryovial containing the biological material can be (a) removed from the cryorack holder and/or the controlled-rate freezer and (b) inserted into the liquid nitrogen storage rack that is removably positionable or permanently positioned within the liquid nitrogen storage container. In other words, a cryovial containing biological material and stored within a cryorack positioned in a cryorack holder and/or a controlled-rate freezer can be directly transferred to a liquid nitrogen storage rack and/or a liquid nitrogen storage container (a) by removing the cryorack from the cryorack holder and/or the controlled-rate freezer and positioning the cryorack within the liquid nitrogen storage rack and/or a liquid nitrogen storage container, and/or (b) without removing the cryovial from the cryorack, without positioning the cryovial within another storage rack (e.g., a cryopreservation box) configured for or dedicated to only the liquid nitrogen storage container or liquid nitrogen storage rack, and/or without transferring the biological material to another cryovial (e.g., to a ready-to-fill closed cryovial).

At block 886, the method 880 continues by preserving biological material with a liquid nitrogen storage container. In some embodiments, preserving the biological material with a liquid nitrogen storage container can include positioning the biological material within the liquid nitrogen storage container. For example, preserving the biological material with a liquid nitrogen storage container can include positioning a cryovial, cryorack, and/or a liquid nitrogen storage rack (e.g., not already positioned within the liquid nitrogen storage container) into the liquid nitrogen storage container. The cryovial, cryorack, and/or liquid nitrogen storage rack can be removably positioned within the liquid nitrogen storage container. Alternatively, the liquid nitrogen storage rack can be permanently positioned within the liquid nitrogen storage container. Preserving the biological material with the liquid nitrogen storage container can include reducing a temperature of the biological material to cryogenic temperatures.

At block 887, the method 880 continues by removing the cryovial from the cryorack and/or removing the biological material from the cryovial. In some embodiments, removing the cryovial from the cryorack includes removing the cryorack, a cryorack holder, and/or a liquid nitrogen storage rack from an instrument, such as from a controlled-rate freezer and/or a liquid nitrogen storage container. In these and other embodiments, removing the cryovial from the cryorack can include removing the cryorack from a cryorack holder by, for example, (i) lifting the cryorack such that protrusions on a bottom of the cryorack are removed from one or more openings in a shelf of the cryorack holder and (ii) sliding, carrying, or otherwise removing the cryorack from within the cryorack holder. In these and still other embodiments, removing the cryovial from the cryorack can include removing the cryorack from a liquid nitrogen storage rack by, for example, moving a retention bar of the liquid nitrogen storage rack and/or sliding the cryorack out or otherwise removing the cryorack from a slot in the liquid nitrogen storage rack. In some embodiments, removing the cryovial from the cryorack can include removing the cryovial from the cryorack without removing the cryorack, a cryorack holder, and/or a liquid nitrogen storage rack from an instrument, such as from a controlled-rate freezer and/or a liquid nitrogen storage container. For example, the cryorack, the cryorack holder, and/or the liquid nitrogen storage rack can remain in the instrument while the cryovial is removed from the cryorack. Removing the cryovial from the cryorack can include lifting or otherwise removing the cryovial from one or more openings formed in one or more plates of the cryorack.

Removing the biological material from the cryovial can include removing the biological material using one of more laboratory instruments. In these and other embodiments, removing the biological material from the cryovial can include following instructions (e.g., handling instructions, storage instructions, administering instructions, dosage instructions, etc.) printed on a label on the cryovial, on the cryorack, on the cryorack holder, and/or on the liquid nitrogen storage rack. Removing the biological material from the cryovial can include ensuring one or more patient identifiers printed on a label on the cryovial match a patient to whom the biological material is to be administered. Removing the biological material from the cryovial can include allowing the cryorack, the cryovial, and/or the biological material to thaw. Removing the biological material from the cryovial can include administering the biological material to a patient, testing the biological material, or otherwise handling the biological material.

Although the steps of the method 880 are discussed and illustrated in a particular order, the method 880 of FIG. 8 is not so limited. In other embodiments, the steps of the method 880 can be performed in a different order. In these and other embodiments, any of the steps of the method 880 can be performed before, during, and/or after any of the other steps of the method 880. For example, block 883 can be performed before or during block 882; blocks 885 and/or 886 can be performed before or during block 883 and/or 884; and/or block 885 can be performed before or during block 882. Furthermore, a person skilled in the art will readily recognize that the method 880 can be altered and still remain within these and other embodiments of the present technology. For example, one or more steps of the method 880 can be omitted and/or repeated in some embodiments.

### C. Examples

Several aspects of the present technology are set forth in the following examples. Although several aspects of the present technology are set forth in apparatus-, system-, or method-styled examples below, any of the aspects of the present technology can similarly be set forth in other styles of examples in other embodiments.

1. A cryogenic storage rack system, comprising:
a cryorack configured to carry a plurality of cryovials, the cryorack including at least one plate with openings to receive cryovials of the plurality of cryovials; and
a cryorack holder configured to carry the cryorack, the cryorack holder including a shelf having at least one opening configured to be positioned beneath the cryorack when the cryorack is positioned on a top surface of the shelf and the cryorack is carried by the cryorack holder.

2. The cryogenic storage rack system of example 1, wherein the cryorack further includes a protrusion, and wherein the at least one opening is configured to receive protrusion to limit lateral movement of the cryorack with respect to the top surface of the shelf when the cryorack is positioned on the top surface and is carried by the cryorack holder.

3. The cryogenic storage rack system of example 1, wherein:
the at least one opening is at least one first opening; and
the shelf further includes at least one second opening that (a) is larger than the at least one first opening and (b) is configured to be positioned beneath the cryorack when the cryorack is positioned on the top surface of the shelf and is carried by the cryorack holder.

4. The cryogenic storage rack system of any of examples 1-3, wherein:
the shelf is a first shelf; and
the cryorack holder further includes:
   a second shelf, and
   a plurality of standoffs configured to (a) separate the first shelf from the second shelf and (b) retain the first shelf and the second shelf in a stacked configuration.

5. The cryogenic storage rack system of any of examples 1-4, wherein:
the at least one plate of the cryorack includes a first plate and a second plate; and
the cryorack further includes a plurality of standoffs configured to (a) separate the first plate from the second plate and (b) retain the first plate and the second plate in a stacked configuration with the first plate positioned above the second plate.

6. The cryogenic storage rack system of example 5 wherein:
the first plate includes a plurality of first openings configured to receive the cryovials of the plurality of cryovials;
the second plate includes a plurality of second openings configured to receive the cryovials of the plurality of cryovials; and
the first openings are larger than the second openings.

7. The cryogenic storage rack system of example 5 or example 6, wherein:
the at least one plate of the cryorack further includes a third plate;
the plurality of standoffs is configured to (a) separate the first plate from the third plate, (b) separate the second plate from the third plate, and (c) retain the first plate, the second plate, and the third plate in the stacked configuration with the third plate positioned between the first plate and the second plate.

8. The cryogenic storage rack system of any of examples 5-7, wherein:
the cryorack further includes a protrusion;
the protrusion is formed at least in part by a standoff of the plurality of standoffs; and
the standoff is positioned at (a) a corner of the first plate or the second plate, and/or (b) along or near a perimeter of the first plate or the second plate.

9. The cryogenic storage rack system of any of examples 5-7, wherein:
the cryorack further includes a protrusion;
the protrusion is formed at least in part by a standoff of the plurality of standoffs; and
the standoff is positioned at least a quarter of a distance from a perimeter of the first plate or the second plate towards a center of the first plate or the second plate, respectively.

10. The cryogenic storage rack system of any of examples 1-9, wherein:
the cryorack is a first cryorack, the plurality of cryovials is a first plurality of cryovials, and the cryovials of the first plurality of cryovials each has a first diameter;
the cryogenic storage rack system further includes a second cryorack configured to carry a second plurality of cryovials;
the second cryorack includes at least one plate with openings to receive cryovials of the second plurality of cryovials;
the cryovials of the second plurality of cryovials each has a second diameter different from the first diameter; and
the cryorack holder is further configured to carry the second cryorack.

11. The cryogenic storage rack system of example 10, wherein:
the shelf is a first shelf;
the cryorack holder includes a second shelf; and
the cryorack holder is configured to simultaneously carry the first cryorack and the second cryorack such that (a) the first cryorack and the second cryorack are both positioned on the first shelf, (b) the first cryorack and the second cryorack are both positioned on the second shelf, or (c) one of the first cryorack and the second cryorack is positioned on the first shelf and another of the first cryorack and the second cryorack is positioned on the second shelf.

12. The cryogenic storage rack system of any of examples 1-11, wherein:
the cryovials of the plurality of cryovials are first cryovials;
each of the first cryovials has a first diameter;
the openings of the at least one plate of the cryorack are first openings;
the at least one plate includes second openings configured to receive second cryovials of the plurality of cryovials; and
the second cryovials each has a second diameter different from the first diameter.

13. The cryogenic storage rack system of any of examples 1-13, wherein the cryorack holder has dimensions corresponding to an interior of a controlled-rate freezer such that the cryorack holder is positionable within the interior of the controlled-rate freezer.

14. The cryogenic storage rack system of any of examples 1-14, wherein:
the cryorack has dimensions corresponding to a liquid nitrogen storage rack such that the cryorack is positionable within the liquid nitrogen storage rack; and
the liquid nitrogen storage rack is configured to fit within a liquid nitrogen storage container.

15. The cryogenic storage rack system of any of examples 1-14, wherein the plurality of cryovials includes ready-to-fill closed vials.

16. A cryogenic storage rack, comprising:
a first plate with one or more openings configured to receive one or more cryovials;
a second plate; and
a plurality of standoffs configured to (a) separate the first plate from the second plate and (b) retain the first plate and the second plate in a stacked arrangement with the first plate positioned over the second plate,
wherein the cryogenic storage rack is configured to be received in (a) a cryogenic storage rack holder that is positionable within a controlled-rate freezer and (b) a liquid nitrogen storage rack that is positionable within a liquid nitrogen storage container.

17. The cryogenic storage rack of example 16, wherein each standoff of the plurality of standoffs includes:
a body portion positionable between the first plate and the second plate such that the first plate is separated from the second plate; and
a center rod configured to extend through a corresponding aperture in the second plate from a top surface of the second plate to a bottom surface of the second plate such that an end of the center rod protrudes a first distance beyond the bottom surface.

18. The cryogenic storage rack of example 17, wherein the corresponding aperture of at least one standoff of the plurality of standoffs is positioned along a perimeter of the second plate and/or at a corner of the second plate.

19. The cryogenic storage rack of example 17 or example 18, wherein the corresponding aperture of a standoff of the plurality of standoffs is positioned at least a quarter of a way from a perimeter of the second plate to a center of the second plate.

20 The cryogenic storage rack of any of examples 16-19, wherein:
the cryogenic storage rack further comprises a third plate with one or more openings corresponding to the one or more openings of the first plate; and
the plurality of standoffs is further configured to (a) separate the first plate from the third plate, (b) separate the second plate from the third plate, and (c) retain the first plate, the second plate, and the third plate in the stacked arrangement with the third plate positioned between the first plate and the second plate.

21 The cryogenic storage rack of example 16 or example 20, wherein at least one standoff of the plurality of standoffs is welded to the first plate, the second plate, or a combination thereof.

22. A cryogenic storage rack holder, comprising:
a first shelf;
a second shelf; and
a plurality of standoffs configured to (a) separate the first shelf from the second shelf and (b) retain the first shelf and the second shelf in a stacked arrangement with one of the first shelf and the second shelf positioned over another of the first shelf and the second shelf,
wherein:
   the first shelf includes (i) a first opening having a first size and (ii) a second opening having a second size,
   the second opening is positioned proximate a perimeter of the first opening, and
   the second opening is configured to receive at least a portion of a cryogenic storage rack such that the second opening limits lateral movement of the cryogenic storage rack with respect to a top surface of the first shelf when the cryogenic storage rack is positioned on the top surface of the first shelf and the portion of the cryogenic storage rack is positioned within the second opening.

23. The cryogenic storage rack holder of example 22, wherein:
the cryogenic storage rack is a first cryogenic storage rack;
the second shelf includes a third opening having a third size and a fourth opening having a fourth size;
the fourth opening is positioned proximate a perimeter of the third opening; and
the fourth opening is configured to receive at least a portion of a second cryogenic storage rack such that the fourth opening limits lateral movement of the second cryogenic storage rack with respect to a top surface of the second shelf when the second cryogenic storage rack is positioned on the top surface of the second shelf and the portion of the second cryogenic storage rack is positioned within the fourth opening.

24. The cryogenic storage rack holder of example 22 or example 23, wherein each standoff of the plurality of standoffs includes:
a body portion positionable between the first shelf and the second shelf such that the first shelf is separated from the second shelf; and
a center rod configured to extend through a corresponding aperture in the first shelf and/or through a corresponding aperture in the second shelf.

25. The cryogenic storage rack holder of any of examples 22-24, wherein:
the cryogenic storage rack holder further comprises a third shelf; and
the plurality of standoffs is further configured to (a) separate the first shelf from the third shelf, (b) separate the second shelf from the third shelf, and (c) retain the first shelf, the second shelf, and the third shelf in the stacked arrangement with the third shelf positioned between the first shelf and the second shelf.

26. The cryogenic storage rack holder of any of examples 22-25, wherein, in the stacked arrangement, the cryogenic storage rack holder has dimensions corresponding to an interior of a controlled-rate freezer such that the cryogenic storage rack holder is positionable within the interior of the controlled-rate freezer.

27. The cryogenic storage rack holder of example 22, example 23, example 25, or example 26, wherein the at least one standoff of the plurality of standoffs is welded to the first shelf, the second shelf, or a combination thereof.

28 A method, comprising:
positioning a cryogenic vial in a cryogenic storage rack;
positioning the cryogenic storage rack in a cryogenic storage rack holder that is positionable within a controlled-rate freezer; and
positioning the cryogenic storage rack within a liquid nitrogen storage rack that is positionable within a liquid nitrogen storage container.

29. The method of example 28, wherein positioning the cryogenic vial in the cryogenic storage rack includes inserting the cryogenic vial in an opening formed in a plate of the cryogenic storage rack such that (a) the cryogenic vial is retained in a vertical orientation and (b) lateral movement of the cryogenic vial is limited at least in part by sides of the opening.

30. The method of example 28 or example 29, wherein the cryogenic vial is a ready-to-fill closed cryogenic vial.

31. The method of any of examples 28-30, wherein positioning the cryogenic storage rack in the cryogenic storage rack holder includes (a) positioning the cryogenic storage rack above a first opening formed in a shelf of the cryogenic storage rack holder and (b) inserting a portion of the cryogenic storage rack into the first opening and/or into a second opening formed in the shelf such that lateral movement of the cryogenic storage rack with respect to a top surface of the shelf is limited by sides of the first opening or by sides of the second opening.

32. The method of any of examples 28-31, wherein positioning the cryogenic storage rack in the liquid nitrogen storage rack includes (a) removing the cryogenic storage rack from the cryogenic storage rack holder and (b) positioning the cryogenic storage rack in the liquid nitrogen storage rack without removing the cryogenic vial from the cryogenic storage rack.

### D. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated by reference herein conflicts with the present disclosure, the present disclosure controls.

Where the context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same feature(s) and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.” Also, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A cryogenic storage rack system, comprising:
a cryorack configured to carry a plurality of cryovials, the cryorack including at least one plate with openings to receive cryovials of the plurality of cryovials; and
a cryorack holder configured to carry the cryorack, the cryorack holder including a shelf having at least one opening configured to be positioned beneath the cryorack when the cryorack is positioned on a top surface of the shelf and the cryorack is carried by the cryorack holder.

2. The cryogenic storage rack system of claim 1, wherein the cryorack further includes a protrusion, and wherein the at least one opening is configured to receive protrusion to limit lateral movement of the cryorack with respect to the top surface of the shelf when the cryorack is positioned on the top surface and is carried by the cryorack holder.

3. The cryogenic storage rack system of claim 1, wherein:
the at least one opening is at least one first opening; and
the shelf further includes at least one second opening that (a) is larger than the at least one first opening and (b) is configured to be positioned beneath the cryorack when the cryorack is positioned on the top surface of the shelf and is carried by the cryorack holder.

4. The cryogenic storage rack system of claim 1, wherein:
the shelf is a first shelf; and
the cryorack holder further includes:
a second shelf, and
a plurality of standoffs configured to (a) separate the first shelf from the second shelf and (b) retain the first shelf and the second shelf in a stacked configuration.

5. The cryogenic storage rack system of claim 1, wherein:
the at least one plate of the cryorack includes a first plate and a second plate; and
the cryorack further includes a plurality of standoffs configured to (a) separate the first plate from the second plate and (b) retain the first plate and the second plate in a stacked configuration with the first plate positioned above the second plate.

6. The cryogenic storage rack system of claim 5 wherein:
the first plate includes a plurality of first openings configured to receive the cryovials of the plurality of cryovials;
the second plate includes a plurality of second openings configured to receive the cryovials of the plurality of cryovials; and
the first openings are larger than the second openings.

7. The cryogenic storage rack system of claim 5, wherein:
the at least one plate of the cryorack further includes a third plate;
the plurality of standoffs is configured to (a) separate the first plate from the third plate, (b) separate the second plate from the third plate, and (c) retain the first plate, the second plate, and the third plate in the stacked configuration with the third plate positioned between the first plate and the second plate.

8. The cryogenic storage rack system of claim 5, wherein:
the cryorack further includes a protrusion;
the protrusion is formed at least in part by a standoff of the plurality of standoffs; and
the standoff is positioned at (a) a corner of the first plate or the second plate, and/or (b) along or near a perimeter of the first plate or the second plate.

9. The cryogenic storage rack system of claim 5, wherein:
the cryorack further includes a protrusion;
the protrusion is formed at least in part by a standoff of the plurality of standoffs; and
the standoff is positioned at least a quarter of a distance from a perimeter of the first plate or the second plate towards a center of the first plate or the second plate, respectively.

10. The cryogenic storage rack system of claim 1, wherein:
the cryorack is a first cryorack, the plurality of cryovials is a first plurality of cryovials, and the cryovials of the first plurality of cryovials each has a first diameter;
the cryogenic storage rack system further includes a second cryorack configured to carry a second plurality of cryovials;
the second cryorack includes at least one plate with openings to receive cryovials of the second plurality of cryovials;
the cryovials of the second plurality of cryovials each has a second diameter different from the first diameter; and
the cryorack holder is further configured to carry the second cryorack.

11. The cryogenic storage rack system of claim 10, wherein:
the shelf is a first shelf;
the cryorack holder includes a second shelf; and
the cryorack holder is configured to simultaneously carry the first cryorack and the second cryorack such that (a) the first cryorack and the second cryorack are both positioned on the first shelf, (b) the first cryorack and the second cryorack are both positioned on the second shelf, or (c) one of the first cryorack and the second cryorack is positioned on the first shelf and another of the first cryorack and the second cryorack is positioned on the second shelf.

12. The cryogenic storage rack system of claim 1, wherein:
the cryovials of the plurality of cryovials are first cryovials;
each of the first cryovials has a first diameter;
the openings of the at least one plate of the cryorack are first openings;
the at least one plate includes second openings configured to receive second cryovials of the plurality of cryovials; and
the second cryovials each has a second diameter different from the first diameter.

13. The cryogenic storage rack system of claim 1, wherein the cryorack holder has dimensions corresponding to an interior of a controlled-rate freezer such that the cryorack holder is positionable within the interior of the controlled-rate freezer.

14. The cryogenic storage rack system of claim 1, wherein:
the cryorack has dimensions corresponding to a liquid nitrogen storage rack such that the cryorack is positionable within the liquid nitrogen storage rack; and
the liquid nitrogen storage rack is configured to fit within a liquid nitrogen storage container.

15. The cryogenic storage rack system of claim 1, wherein the plurality of cryovials includes ready-to-fill closed vials.

16. A cryogenic storage rack, comprising:
a first plate with one or more openings configured to receive one or more cryovials;
a second plate; and
a plurality of standoffs configured to (a) separate the first plate from the second plate and (b) retain the first plate and the second plate in a stacked arrangement with the first plate positioned over the second plate,
wherein the cryogenic storage rack is configured to be received in (a) a cryogenic storage rack holder that is positionable within a controlled-rate freezer and (b) a liquid nitrogen storage rack that is positionable within a liquid nitrogen storage container.

17. The cryogenic storage rack of claim 16, wherein each standoff of the plurality of standoffs includes:
a body portion positionable between the first plate and the second plate such that the first plate is separated from the second plate; and
a center rod configured to extend through a corresponding aperture in the second plate from a top surface of the second plate to a bottom surface of the second plate such that an end of the center rod protrudes a first distance beyond the bottom surface.

18. The cryogenic storage rack of claim 17, wherein the corresponding aperture of at least one standoff of the plurality of standoffs is positioned along a perimeter of the second plate and/or at a corner of the second plate.

19. The cryogenic storage rack of claim 17, wherein the corresponding aperture of a standoff of the plurality of standoffs is positioned at least a quarter of a way from a perimeter of the second plate to a center of the second plate.

20. The cryogenic storage rack of claim 16, wherein:
the cryogenic storage rack further comprises a third plate with one or more openings corresponding to the one or more openings of the first plate; and
the plurality of standoffs is further configured to (a) separate the first plate from the third plate, (b) separate the second plate from the third plate, and (c) retain the first plate, the second plate, and the third plate in the stacked arrangement with the third plate positioned between the first plate and the second plate.

21. The cryogenic storage rack of claim 16, wherein at least one standoff of the plurality of standoffs is welded to the first plate, the second plate, or a combination thereof.

22. A cryogenic storage rack holder, comprising:
a first shelf;
a second shelf; and
a plurality of standoffs configured to (a) separate the first shelf from the second shelf and (b) retain the first shelf and the second shelf in a stacked arrangement with one of the first shelf and the second shelf positioned over another of the first shelf and the second shelf,
wherein:
the first shelf includes (i) a first opening having a first size and (ii) a second opening having a second size,
the second opening is positioned proximate a perimeter of the first opening, and
the second opening is configured to receive at least a portion of a cryogenic storage rack such that the second opening limits lateral movement of the cryogenic storage rack with respect to a top surface of the first shelf when the cryogenic storage rack is positioned on the top surface of the first shelf and the portion of the cryogenic storage rack is positioned within the second opening.

23. The cryogenic storage rack holder of claim 22, wherein:
the cryogenic storage rack is a first cryogenic storage rack;
the second shelf includes a third opening having a third size and a fourth opening having a fourth size;
the fourth opening is positioned proximate a perimeter of the third opening; and
the fourth opening is configured to receive at least a portion of a second cryogenic storage rack such that the fourth opening limits lateral movement of the second cryogenic storage rack with respect to a top surface of the second shelf when the second cryogenic storage rack is positioned on the top surface of the second shelf and the portion of the second cryogenic storage rack is positioned within the fourth opening.

24. The cryogenic storage rack holder of claim 22, wherein each standoff of the plurality of standoffs includes:
a body portion positionable between the first shelf and the second shelf such that the first shelf is separated from the second shelf; and
a center rod configured to extend through a corresponding aperture in the first shelf and/or through a corresponding aperture in the second shelf.

25. The cryogenic storage rack holder of claim 22, wherein:
the cryogenic storage rack holder further comprises a third shelf; and
the plurality of standoffs is further configured to (a) separate the first shelf from the third shelf, (b) separate the second shelf from the third shelf, and (c) retain the first shelf, the second shelf, and the third shelf in the stacked arrangement with the third shelf positioned between the first shelf and the second shelf.

26. The cryogenic storage rack holder of claim 22, wherein, in the stacked arrangement, the cryogenic storage rack holder has dimensions corresponding to an interior of a controlled-rate freezer such that the cryogenic storage rack holder is positionable within the interior of the controlled-rate freezer.

27. The cryogenic storage rack holder of claim 22, wherein at least one standoff of the plurality of standoffs is welded to the first shelf, the second shelf, or a combination thereof.

28. A method, comprising:
positioning a cryogenic vial in a cryogenic storage rack;
positioning the cryogenic storage rack in a cryogenic storage rack holder that is positionable within a controlled-rate freezer; and
positioning the cryogenic storage rack within a liquid nitrogen storage rack that is positionable within a liquid nitrogen storage container.

29. The method of claim 28, wherein positioning the cryogenic vial in the cryogenic storage rack includes inserting the cryogenic vial in an opening formed in a plate of the cryogenic storage rack such that (a) the cryogenic vial is retained in a vertical orientation and (b) lateral movement of the cryogenic vial is limited at least in part by sides of the opening.

30. The method of claim 28, wherein the cryogenic vial is a ready-to-fill closed cryogenic vial.

31. The method of claim 28, wherein positioning the cryogenic storage rack in the cryogenic storage rack holder includes (a) positioning the cryogenic storage rack above a first opening formed in a shelf of the cryogenic storage rack holder and (b) inserting a portion of the cryogenic storage rack into the first opening and/or into a second opening formed in the shelf such that lateral movement of the cryogenic storage rack with respect to a top surface of the shelf is limited by sides of the first opening or by sides of the second opening.

32. The method of claim 28, wherein positioning the cryogenic storage rack in the liquid nitrogen storage rack includes (a) removing the cryogenic storage rack from the cryogenic storage rack holder and (b) positioning the cryogenic storage rack in the liquid nitrogen storage rack without removing the cryogenic vial from the cryogenic storage rack.
